(19) United States
(12) Patent Application Publication
(10) Pub. No.: US 2009/0177550 A1
(43) Pub. Date: Jul. 9, 2009

(54) Methods and Systems for Offering and Selling Advertising

(75) Inventor: Christina Tutone, Point Cook (AU)

Correspondence Address: SUGHRUE MION, PLLC, 2100 PENNSYLVANIA AVENUE, N.W., SUITE 800, WASHINGTON, DC, 20037, US

(73) Assignee: Christina Tutone

(21) Appl. No.: 12/405,205

(22) Filed: Mar. 16, 2009

Related U.S. Application Data
(63) Continuation of application No. 11/630,316, filed on Mar. 27, 2007.

(30) Foreign Application Priority Data
Jun. 22, 2005 (AU) 2005903286
Oct. 28, 2005 (AU) 2005100915
Dec. 1, 2006 (AU) 2006906740

(51) Int. Cl. G06Q 30/00; G06F 17/30; G06Q 10/00

(52) U.S. Cl. 705/14; 707/3; 705/26; 705/400; 707/E17.014; 707/E17.044

(57) ABSTRACT

A method (22) for coordinating information for use in advertising. The method (22) comprises receiving sets of advertisement information (26) associated with advertisements for distressed advertising space (28). The sets of advertisement information (26) are stored and the method (22) includes searching the stored sets of advertisement information (22) to locate at least one set (38) that meets with distressed advertising criteria (36). Other aspects are provided.

### FIELD OF INVENTION

In one aspect the present invention relates to the field of advertising. In other aspects the present invention relates to sponsorship.

Preferred arrangements of the present invention provide online methods and systems for offering and selling distressed advertising space.

The media may include print, internet, or any form of communications media. Examples include online media, outdoor media, ambient media, electronic media, other media inclusive of new media types as they become available.

The disclosure of Australian Provisional Patent 2005903286 filed 22 Jun. 2005 is hereby fully incorporated by reference. In addition the disclosure of Australian Innovation Patent AU20051009125 filed 28 Oct. 2005 is hereby fully incorporated by reference. Furthermore, the disclosure of PCT patent application number PCT/AU2006/00883 filed 22 Jun. 2006 is hereby fully incorporated by reference.

It will be convenient to hereinafter describe, in some parts, the invention in relation to distressed advertising however it should be appreciated that the present invention is not limited to that use only.

### BACKGROUND ART

The discussion throughout this specification comes about due to the realisation of the inventor(s) and/or the identification of certain prior art problems by the inventor(s).

Most forms of media have a designated percentage or amount of space which is set aside or made available for advertising such that, individuals and/or companies are able to advertise their products and/or services in return for the money they provide to the publication for exposure of their advertisement.

In this connection the present invention seeks to provide an improvement, or at least provide the public with a useful choice.

Furthermore these forms of media are subject to deadlines which can be problematic considering the designated space set aside for advertising. Consequently, when a deadline is approaching, for a given media, any last minute advertising space which has not yet been sold will generally be offered by the media publisher at a discounted rate to existing clients or given away as a bonus to ensure that publication of the media can be completed on time.

In this connection the present invention seeks to provide an improvement, or at least provide the public with a useful choice.

Typically Web Page banners operate on a click through system where a resource uses a log file system to detect a locator indicative of a resource providing the web page on which the banner was clicked. The resource then takes action to provide some small amount of money to the resource providing the banner, or a party associated therewith.

Web page banners are typically considered as a subsidiary tier of advertising. In this connection the present invention seeks to provide an improvement, or at least provide the public with a useful choice.

Present online systems suffer from a number of further issues that have been identified by the inventors. If these issues could be dealt with to the benefit of both sellers, buyers and/or agencies this would be advantageous.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

### A Advertising

According to an aspect of the invention there is provided an advertising method comprising:

receiving advertisement information associated with advertising space; and

sending advertisement information having a relationship with the advertisement information received.

Preferably, the advertisement information relates to distressed advertising.

In accordance with another aspect, the present invention provides a method of and/or system for providing advertising, the method comprising selecting a medium in which to place the advertising, and providing the advertising content, at least partially in accordance with a method as disclosed herein.

The advertisement, advertisement space and/or advertisement information as herein referred to may relate to at least any or any combination of retail advertising, discount advertising, block advertising, or distressed advertising.

The term “distressed advertising” is hereby defined as last minute or unsold advertising. The media is preferably online publishing media.

The term “block advertising” is hereby defined as comprising, without limitation, advertising being predefined, of a predefined duration, of a predefined specification (such as size) and may also include a number or variety of advertisements or a bulk (plurality) of advertisements as a collective of advertisements. Even though block advertising may be uploaded to the present invention, a user or purchaser of advertising space may choose to purchase any one or any combination of advertisements within the block of advertising as a single transaction.

### B Distressed Advertising

According to an aspect of the invention there is provided a method of and/or system for coordinating information for use in advertising, the method comprising:

receiving sets of advertisement information associated with advertisements for distressed advertising space;

storing the sets of advertisement information; and

searching the stored sets of advertisement information to locate at least one set that meets with distressed advertising criteria.

According to an aspect of the invention there is provided a system of and/or system for coordinating information for use in advertising, the system comprising:

receiving means for receiving sets of advertisement information associated with advertisements for distressed advertising space;

storing means for storing the sets of advertisement information; and

searching means for searching the stored sets of advertisement information to locate at least one set that meets with distressed advertising criteria.

It is to be appreciated that preferred features of methods of the present invention described herein could equally be applied to preferred systems in the form of means for achieving or performing. The skilled addressee is expected to exercise his or her better judgement where explicit detail is not provided of an equivalent method feature, or system features is not provided.

For example, the method preferably includes receiving sets of advertisement information each offering a distressed advertising space for sale and the receiving means for receiving the sets of advertisement information preferably comprises means for receiving sets of advertisement information each offering a distressed advertisement space for sale.

The method preferably includes receiving sets of advertisement information each offering a distressed advertising space for sale.

The receiving means for receiving the sets of advertisement information is preferably for receiving sets of advertisement information each offering a distressed advertising space for sale

The method preferably includes receiving sets of advertisement information each offering an advertisement for use in distressed advertising. The receiving means for receiving the sets of advertisement information is preferably for receiving sets of advertisement information each offering a distressed advertisement for use in distressed advertising.

Preferably the means for receiving the sets of advertisement information is adapted to receive an offer of distressed advertisement space for sale along with at least one of a predetermined plurality of urgency indicators.

As noted above, further aspects and preferred aspects are disclosed in the specification below and/or defined in the appended claims, forming a part of the description of the invention.

It is to be appreciated that It that some preferred arrangements of the present invention are directed towards allowing publication companies and/or media suppliers to source distressed advertising in view of advertisement requirements. These preferred arrangements also preferably have the advantage of allowing a group of advertisement space purchasers to buy distressed advertising, for a wide variety of products and services, from publication companies and/or media suppliers for a comparatively low price in comparison to the likelihood of gaining advertising exposure.

It is preferred that the invention is focussed towards targeted consumers such as marketers, advertising buyers or other professionals wishing to purchase or sell advertising. The invention may accordingly including offering advertisements for distressed advertising space or offering distressed advertising space to a targeted group.

It is preferred that the system includes means for providing an online graphical user interface via a world wide system such that buyer(s) and seller(s) are able to send the sets of information to means for receiving the information. The system may be a mobile telephone system. The system may provide an online interface associated with a website using which the buyer(s) and seller(s) can access on a computer connected to the server in order to interact with the server.

For example a method or system may be provided which facilitates offering and selling distressed advertising by providing a resource and a locator, the locator serving to identify graphical user interface connected to the resource to allow distressed advertising space to be offered to marketers, advertising buyers and other persons who wish to purchase advertising space in a particular media forum and/or for a particular target audience and to allow advertisements to be offered to publication companies or other persons for use in distressed advertising space.

It is preferred that the website has at least one web page provided with at least one category and/or subheading to assist a user in navigating around the website.

It is further preferred that each category may be provided with at least one advertisement for use in distressed advertising.

It is preferred that users of the inventions should become members in order to obtain appropriate access to the website.

It is preferred that arrangements of invention may be able to provide a user with statistical information such that they are able to evaluate the existing or ongoing trends in the marketplace.

It is preferred that arrangements of the invention provide an option which enables a customer to obtain financial assistance.

At present, the only methods and/or systems available in relation to advertising in an online environment involve websites which allow an individual and/or company to place an advertisement for their product(s) and/or service(s). These existing systems fail to provide a solution for advertising space in publications and media and in particular, fail to provide a means which enables publication companies and/or media suppliers to offer and sell distressed advertising to marketers, advertising buyers and other professionals who wish to purchase median advertising.

It is considered that publication companies and/or media suppliers seeking to sell distressed advertising and marketers, advertising buyers and other professionals wishing to purchase median advertising will find preferred arrangements of the present invention most advantageous.

According to an aspect of the invention there is provided a method of and/or system for coordinating information for use in advertising, the method comprising:

receiving sets of advertisement information each offering an advertisement for use in distressed advertising;

storing the sets of advertisement information;

searching the stored sets of advertisement information each offering an advertisement to locate at least one set that meets with distressed advertising criteria.

Preferably the method includes receiving a set of advertisement information associated with an offer of distressed advertising space for sale, the set of information containing the advertising criteria.

According to an aspect of the invention there is provided a method of and/or system for coordinating information for use in advertising, the method comprising:

receiving sets of advertisement information each offering an advertising space for sale;

storing the sets of advertisement information;

searching the stored sets of advertisement information each offering an advertisement space for sale to locate at least one set that meets distressed advertising criteria.

Preferably the method includes receiving a set of advertisement information associated with an advertisement for use in distressed advertising, the set of information containing the advertising criteria.

The advertisement may be a potential advertisement and the distressed advertising space may be a potential distressed advertising space. Preferably the method includes receiving at least one confirmation.

Further aspects and preferred aspects are disclosed in the specification below and/or defined in the appended claims, forming a part of the description of the invention. This statement applies equally to all parts of this specification.

### C Prepopulation

Preferably the method includes prepopulating items for use in the set of advertisement information offering distressed advertising space for sale. The set of advertisement information offering the distressed advertising space for sale may be stored for later use in further prepopulation.

Preferably method includes prepopulating items for use in the set of advertisement information offering an advertisement for use in distressed advertising. The set of advertisement information offering the advertisement for use in distressed advertising may be stored for later use in further prepopulation.

### D Seller Levels Pricing Schedule

Preferably the method includes controlling a set of advertisement information offering distressed advertising space for sale, such that an amount requested for the sale meets with a pricing schedule.

Preferably the method includes controlling a set of advertisement information offering an advertisement for use in distressed advertising, such that an amount offered for the distressed advertising meets with a pricing schedule.

Preferably the method includes searching membership information to determine the pricing schedule. In some arrangements controlling the set of advertisement information includes modifying the set of advertisement information.

Preferably the method includes limiting the amount to an amount substantially reduced in comparison to conventional advertising. Preferably an amount offered or requested is matched against a threshold.

### E Optional Extras

Preferably the method includes providing an option of modifying a set of advertisement information to include a particular item. The item may consist of a background colour optionally selected for the distressed advertising. Preferably the method includes determining a sale amount according to the option.

According to another aspect of the invention there is provided a method of and/or system for coordinating information for use in advertising, the method comprising:

receiving a set of advertisement information associated with advertisements for advertising space, the set thereafter becoming a member of a number of received sets of advertisement information; and

providing an option of controlling the set of advertisement information to include a particular item and determining a sale amount according to the option.

As with all methods disclosed herein, associated systems adapted to perform the method are envisaged

Preferably the set of advertisement information offers an advertising space for sale and the option is at least one of a desired colour, image, specialised display format, priority listing and target market listing.

### F Discounted Packages

An aspect of the present invention provides a method of and/or system comprising:

receiving a first set of advertisement information associated with a first publication media;

receiving a second set of advertisement information associated with a second publication media; and

forming a resultant set of advertisement information associated with a discounted package, said forming including combining the first set of advertisement information and the second set of advertisement information.

Preferably said forming is subject to subject to the second publication media being different to the first publication media. In this regard the method preferably includes determining a sale amount that is discounted given that the first publication media is different to the second publication media.

Preferably the method includes receiving three sets of advertisement information each associated with a respective publication media, the three sets including the first and second sets, and subject to the respective publication media being different, said forming including combining the respective sets of advertisement information.

Preferably the sets are combined according to predetermined criteria.

### G Search Services Matching

According to an aspect of the invention there is provided a method of and/or system for coordinating information for use in advertising, the method comprising:

receiving sets of advertisement information associated with advertisements for advertising space;

storing the sets of advertisement information; and

controlling the input of advertising criteria to specify a search selected from a group specifying at least a national or international based search;

searching the stored sets of advertisement information to locate at least one set that meets with advertising criteria.

Preferably the advertising space is distressed advertising space.

### H Reverse Search

According to an aspect of the invention there is provided a method of and/or system for coordinating information for use in advertising, the method comprising:

receiving sets of advertisement information each offering an advertisement for use in distressed advertising; and

storing the sets of advertisement information;

wherein each of the sets of advertisement information, each offering an advertisement for use in distressed advertising, include an associated sale amount to enable searching according to distressed advertising criteria specifying a limitation on the associated sale amounts.

According to an aspect of the invention there is provided a method of and/or system for coordinating information for use in advertising, the method comprising:

receiving sets of advertisement information each offering an advertisement for use in distressed advertising and including an associated sale amount;

storing the sets of advertisement information;

searching the stored sets of advertisement information each offering an advertisement to locate at least one set that meets with distressed advertising criteria specifying a limitation on the associated sale amounts.

The advertising industry is particularly cut throat especially in particular industry areas such as the newspaper industry in which prices are set with many variables according to media buyers and their staff. In the industry leads are particularly difficult to obtain especially on a nationally basis for small media companies and also large media companies who deal predominantly with advertisement agencies.

The reverse search preferably caters for these typical variables and allows for an auction system. This advantageously will enable media companies to curb costs by having their staff focus on retail sales instead of trying to move distressed stock. In embodiments the method is geared to either providing a higher price for the seller of the advertising space or a lower price for the buyer of the advertising space.

### G Auction

According to an aspect of the invention there is provided a method of and/or system for coordinating information for use in advertising, the method comprising:

initiating an auction;

receiving sets of advertisement information associated with advertisements for distressed advertising space and each including associated sale amounts; and

selecting, within the auction, one of the sets of advertisement information based on the associated sale amounts.

In embodiments, the advertisements may be provided to the customers in an auction format.

### H Other Media Types

According to an aspect of the invention there is provided a method of and/or system for coordinating information for use in advertising, the method comprising:

receiving sets of advertisement information associated with advertisements for advertising space; and

storing the sets of advertisement information; and

searching the stored sets of advertisement information to locate at least one set that meets with distressed advertising criteria;

wherein the sets of advertisement information relate to at least one media type selected from the group of print advertising, television advertising, radio advertising.

The provision of a web portal that caters for a plurality of media types is particularly advantageous. Specific combinations may include print, television radio advertising and bill board advertising. With major media companies various departments are provided for various publication types. In embodiments of the invention a single web portal allows a member to manage many media types or publications in one system if they choose to. The group may include media including online media, outdoor media, ambient media, electronic media, other media, inclusive of new media types as they become available.

### I Banners

According to an aspect of the invention there is provided a method of and/or system for coordinating information for use in advertising, the method comprising:

receiving a set of advertisement information associated with advertisements for banner advertising space; and

associating the set with a respective banner advertisement.

Associating the set with a respective banner advertisement may include building the banner advertisement.

According to an aspect of the invention there is provided a method of and/or system for coordinating information for use in advertising, the method comprising:

receiving sets of advertisement information associated with advertisements for banner advertising space; and

connecting each of sets of advertisement information such that each set is associated with a respective banner advertising space and a respective banner advertisement.

Preferably the set of advertisement information comprises an offer of banner advertising space or an offer of a banner advertisement.

Preferably the method includes storing the sets of advertisement information; and searching the stored sets of advertisement information to locate at least one set that meets with banner advertising criteria.

### J Charity Features

According to another aspect of the invention there is provided a method of and/or system for coordinating information for use in advertising, the method comprising:

receiving a set of advertisement information associated with advertisements for advertising space, the set thereafter becoming a one of a number of received sets of advertisement information; and

providing an option of including a particular item associated with a donation to community conscious party.

Preferably each of the sets of advertisement information each offer an advertisement space for sale and the option comprises letting the community conscious party use the advertisement space if the advertisement space is not sold within a predetermined time period.

### K Sponsorship

According to an aspect of the invention there is provided a method of and/or system for coordinating information for use in sponsorship, the method comprising:

receiving a set of sponsorship information associated with a sponsorship; and

offering a sponsorship based on the set of sponsorship information received.

According to an aspect of the invention there is provided a method for coordinating information for use in sponsorship, the method comprising:

receiving sets of sponsorship information associated with a potential sponsorship; and

connecting each of sets of sponsorship information such that and each set is associated with a respective sponsorship.

### M Design Services

According to an aspect of the invention there is provided a method of and/or system for coordinating information for use in advertising, the method comprising:

allowing the selection of an offer of advertisement space; and

offering a build service to build an advertisement in order that the advertisement will be prepared with a predetermined time frame.

According to an aspect of the invention there is provided a method of and/or system for coordinating information for use in advertising, the method comprising:

receiving a set of advertisement information associated with advertisements for distressed advertising space

offering a build service to build an advertisement in order that the advertisement will be prepared with a predetermined distressed time frame.

Preferably offering the design service comprises offering the design service to build an advertisement using an online environment such that the design is built within minutes. The build service may be performed by a third party such as a graphic artist.

Offering the design service may comprise offering the option of having a designer build the advertisement within 48 hours. Offering the design service may comprise offering the option of having a designer build the advertisement within 24 hours. Offering the design service may comprise offering the option of having a designer build the advertisement within 12 hours. Offering the design service may comprise offering the option of having a designer build the advertisement within 6 hours. Offering the design service may comprise offering the option of having a designer build the advertisement within 1 hour. Offering the design service may comprise offering the option of having a designer build the advertisement within 30 minutes.

It is preferred that the invention includes offering design services which are adapted to have a rapid turnaround to enable a customer to have the design work for their advertising completed prior to the publication or media deadline.

### N One Session Buying

According to an aspect of the invention there is provided an advertising method of and/or system comprising creating a session and, within the session, arranging for the purchase of advertising space, the design of an advertisement and the supply of the designed advertisement within a predetermined time frame.

The ability to perform this action within a single session is most advantageous

### O Campaign Builder

According to an aspect of the invention there is provided an advertising method of and/or system comprising building a campaign for an advertiser.

With this system an online file centre houses marketing plans and templates for advertisements and images. Preferably there is a provided a campaign calendar over which a campaign timeline can be created. The system may provide a wizard enabling members to build a campaign plan online and to save it if they choose into their members centre or they can download it. Equally, this aspect of invention may alert the campaign builder to available advertising in line with the requirements of the campaign built. For example, if an advertising campaign is required for a period of (say) 2 weeks, and advertising is available for any part or all of that two week period, an alert to this available advertising is provided. Furthermore, if there is no advertising available on the present system, following the creation of an advertising campaign, alerts and/or other communications may be forwarded to advertising suppliers to alert them to need for advertising by the campaign created.

In other words, the campaign builder enables our system to log into the created campaigns and data match at anytime with a buyers plan. For example we can cross match their calendar schedule with our database. The campaign wizard has a section that enables the user to add to a calendar a schedule of dates for advertising and media types, we can pull this data and match it with our system and alert the buyer when ads that match their request are available. The present aspect can capture any part or all the campaign data for advertising and that information in association with other features disclosed herein. For example, sending out requests to suppliers that match users media types and inform them that there are certain users looking for their media type in a specific time range etc.

The wizard preferably pulls out keywords which attribute targeted advertising to certain members whilst they are searching or working on their marketing plan.

When a member is writing their plan or typing certain keywords the system will be able to recognise the word and send to the page an advertisement targeted to those keywords. The wizard takes an advertiser through the process of developing an advertising campaign from strategy, creative to purchase all via the system and enables them to set alerts or price set so they can use the specific media they require. The advertisers can also order online production services and have the ability to purchase and order packages whilst setting their campaign timeline.

### Q Alerts

According to an aspect of the invention there is provided a method of and/or system for coordinating information for use in advertising, the method comprising receiving sets of advertisement information associated with advertisements for distressed advertising space; storing the sets of advertisement information; searching the stored sets of advertisement information to locate at least one set that meets with distressed advertising criteria; and sending an alert to a party associated with the at least one set that meets with the distressed advertising criteria.

According to another aspect of the invention there is provided a method of and/or system for coordinating information for use in advertising, the method comprising receiving sets of advertisement information each offering an advertisement for use in distressed advertising, storing the sets of advertisement information; searching the stored sets of advertisement information each offering an advertisement to locate at least one set that meets with distressed advertising criteria; and sending an alert to a party when a set is located that meets with the distressed advertising criteria.

Preferably sending the alert comprises sending the alert to a party offering an advertisement for use in distressed advertising. Sending the alert may comprise sending an urgent alert requiring the party to reply within distressed time period to purchase the distressed advertising space. Preferably this requires that the party has an advertisement completed and ready to make a deadline. The distressed time period may be 30 minutes and the deadline may comprise a couple of hours.

According to still another aspect of the invention there is provided a method of and/or system for coordinating information for use in advertising, the method comprising receiving sets of advertisement information each offering an advertising space for sale; storing the sets of advertisement information; searching the stored sets of advertisement information each offering an advertisement space for sale to locate at least one set that meets with distressed advertising criteria; and sending an alert to a party when a set is located that meets with the distressed advertising criteria.

The advertisement may be a potential advertisement and the distressed advertising space may be a potential distressed advertising space. Preferably the method includes receiving at least one confirmation.

According to yet another aspect of the invention there is provided a method of and/or system for coordinating information for use in advertising, the method comprising a buyer uploading advertising criteria to a database, notifying at least one supplier of the advertising criteria, and notifying the buyer of an acceptance or rejection of the advertising criteria.

### R Highlighting

According to an aspect of the invention there is provided a method of and/or system for coordinating information for use in advertising, the method comprising:

receiving sets of advertisement information associated with advertisements for distressed advertising space;

storing the sets of advertisement information;

searching the stored sets of advertisement information to locate at least one set that meets with distressed advertising criteria; and

highlighting particular sets of advertisement information when said particular sets of advertisement information repetitively do not meet distressed advertising criteria.

Preferably highlighting the sets of advertisement information comprises providing an online publication directing readers to said particular sets.

In another embodiment, the invention may have provided an online newsletter and an e-magazine which contains the advertisement which may take longer to sell such that, the website can constantly be updated and refreshed to provide the latest advertising availabilities to customers.

### S Statistics Gather and Inform

According to an aspect of the invention there is provided a method of and/or system for coordinating information for use in advertising, the method comprising:

receiving sets of advertisement information associated with advertisements for distressed advertising space; and

maintaining statistics on the sets of advertisement information.

According to an aspect of the invention there is provided a method for coordinating information for use in advertising, the method comprising:

receiving sets of advertisement information associated with advertisements for distressed advertising space;

searching the stored sets of advertisement information to locate at least one set that meets with distressed advertising criteria; and

maintaining statistics of the sets of advertisement information.

Preferably maintaining statistics includes maintaining statistics of which of the stored sets of advertisement information are being repetitively searched.

### T ROI Calculator

According to an aspect of the invention there is provided a method of and/or system for determining information for use in advertising, the method comprising receiving a set of advertisement information associated with advertisements for distressed advertising space; and facilitating the calculation of an indication of a required return on investment associated with the set of advertisement information using an online system.

Preferably the method includes suggesting at least one advertisement or at least one distressed advertising space based on the indication.

Preferably the method includes suggesting a marketing strategy.

### U Franchise

The system can be linked directly to other websites or systems so that space can be purchased. For example a franchise company can add a link/frame so that members can access the system without leaving the franchise main website. They can then log in and buy directly from the system. Advertisement agencies will be able to utilise this system to purchase distressed advertising for their clients. Preferably the method includes linking a system for performing the method with a third party such that the third party appears to perform the method.

### V Online Interface

According to an aspect of the invention there is provided a method of and/or system for buying and selling distressed advertising wherein the system includes:

a server having at least one database accessible by at least one subscribing buyer and/or at least one subscribing seller in order to buy and/or sell distressed advertising;

an online interface in the form of a website which provides means for said buyer(s) and/or seller(s) to interact with the server;

a means for enabling said seller(s) to directly upload at least one advertisement for available distressed advertising detailing all relevant information pertinent to said distressed advertising including a fixed price for at least one advertisement;

a search means for enabling said buyer(s) to search and select available distressed advertising;

a payment means for enabling said buyer(s) to directly purchase distressed advertising; and

a means for enabling said buyer(s) to directly upload advertising content.

According to an aspect of the invention there is provided a method of and/or system for buying and selling distressed advertising wherein the method includes the following steps of:

providing a server over a distributed communication network, said server having at least one database accessible by at least one subscribing buyer and/or at least one subscribing seller in order to buy and/or sell distressed advertising;

said seller(s) directly uploading at least one advertisement for use in distressed advertising;

said buyer(s) searching for available distressed advertising by entering at least one search criteria to receive search results detailing available distressed advertising meeting said search criteria via a search means;

said buyer(s) selecting at least one distressed advertising and directly purchasing selected distressed advertising; and

said buyer(s) directly uploading advertising content.

Preferably the distressed advertising is offered and bought at a discounted rate and a design service is provided wherein following purchase of distressed advertising, said buyer(s) can select to have design or creative work completed and uploaded by said design service prior to a specified publication deadline.

### W Import System

In a further embodiment of the present invention, advertisements, and/or advertisement information related to normal (not distressed) advertising may be upload into the system of the present invention. After certain criteria are met, such as a predetermined period of time, price or other criteria as predetermined by the system), the advertising upload, or a portion of that advertising may be designated as ‘distressed’. Equally, if advertisements remain unsold for a period of time on a suppliers system, they may thereafter be imported (pulled or pushed) onto the system of the present invention and be offered as distressed advertising in accordance with other embodiments of the present invention.

In this regard, the present invention provides in accordance with an aspect of invention, a method of and/or system for designating advertising as distressed advertising, comprising providing advertising information in a database, providing predetermined criteria adapted to designate whether the advertising is normal or distressed advertising and allocating the determination to the advertising.

### X International System

In accordance with another embodiment of the present invention, advertising, especially distressed advertising may be provided on an international basis. For example, a person in Australia may wish to purchase advertising, such as distressed advertising in USA. This may be accomplished via an aspect of the present invention.

### Y Multimedia Directory for Advertising

There is a need for SME's to access media advertising. In accordance with another embodiment of the present invention, media access, especially advertising media access is provided by way of a website into which advertising media can be uploaded and searched and viewed by users. Viewing of the media provides a form of advertising medium at relatively low cost and to a potentially large, even international audience. In this regard, in accordance with an aspect of invention, there is provided n online system and method adapted to provide an advertising medium, the system comprising providing a database into which a first user can upload a advertisement content, and providing online access to a second user to enable the second user to view the content.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 is a schematic diagram of a method according to a first embodiment of the invention;

FIG. 2 is a schematic diagram of a method according to a second embodiment of the invention;

FIG. 3 is a schematic diagram of a system according to a third embodiment of the invention;

FIG. 4 is a system/method diagram of the embodiments shown in FIGS. 2 and 3;

FIG. 5 is a schematic diagram of a method according to another embodiment of the invention;

FIG. 6 is schematic diagram of an alert method according to another aspect of the invention;

FIG. 7 is a further system/method diagram of the embodiments shown in FIGS. 2 and 3;

FIG. 8 is a screenshot from a portal illustrated in FIGS. 4 and 5;

FIG. 9 is a schematic diagram of a first embodiment of an alert method according to the present invention;

FIG. 10 is a schematic diagram of a second embodiment of an alert method according to the present invention;

FIG. 11 is a schematic diagram of a system according to another embodiment of the invention;

FIG. 12 is a record diagram used in the embodiment shown in FIG. 11;

FIG. 13 is a schematic diagram of the system illustrated in FIG. 11;

FIGS. 14 and 15 is a schematic diagram of methods according to further embodiments of the invention,

FIG. 16 illustrates an example of a search method according to the present invention,

FIG. 17 is a schematic diagram of a third embodiment of an alert method according to the present invention,

FIG. 18 illustrates a schematic of a further embodiment of the present invention,

FIG. 19 represents an embodiment directed to international advertising, and

FIG. 20 illustrates yet another embodiment of the present invention.

### DETAILED DESCRIPTION

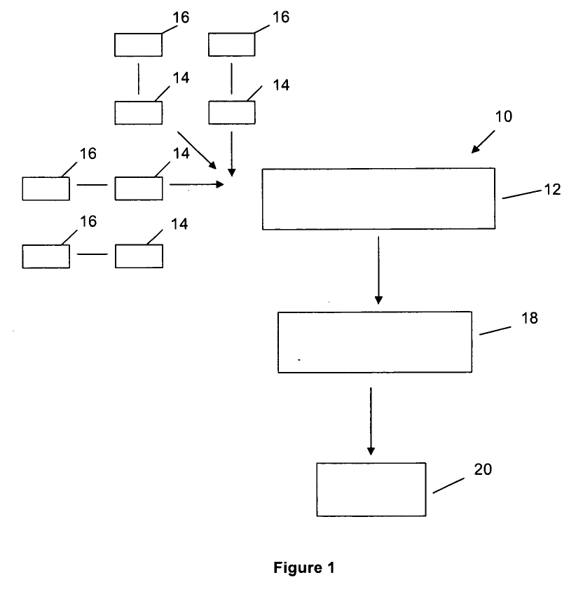

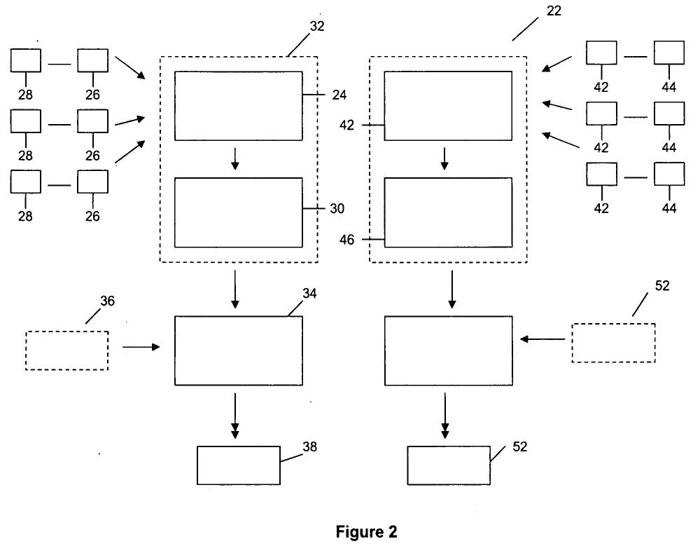

Referring to FIGS. 1 and 2 there is shown an advertising method 10 according to a preferred embodiment of the invention. At block 12 the method 10 includes receiving advertisement information 14 associated with advertising space 16. At block 18 the method 10 includes sending advertisement information 20. The advertisement information 20 sent at block 18 has a relationship with the advertisement information 14 received.

In this particular embodiment the advertisement information 14 and 20 relate to distressed advertising. In other embodiments the advertisement information 14 and 20 relate to retail advertising. In yet further embodiments the advertisement information 14 and 20 relate to discount advertising. Distressed advertising relates to last minute or unsold advertising space.

Referring to FIG. 2 there is shown a method 22 for coordinating information for use in advertising. The method 22 is provided according to another embodiment of the invention. At block 24 the method 22 includes receiving different sets of advertisement information 26 associated with advertisements for distressed advertising space. The different sets of advertisement information 26 each offer a different distressed advertising space 28 for sale.

At block 30 the method 22 includes storing the sets of advertisement information; and once the sets of advertisement information 26 have been received and stored at block 32, the method 22 includes searching at block 34. More specifically at block 34 the stored sets of advertisement information 26 are searched to locate at least one set 38 that meets with distressed advertising criteria 36.

The method 22 further includes at block 40 receiving different sets of advertisement information 42 associated with advertisements for distressed advertising space by each offering an advertisement 44 for use in distressed advertising. The different sets of advertisement information 42 are stored at block 46. In the method 22 there is further provided at block 48 searching the stored sets of advertisement information 42 to locate at least one set 50 that meets with distressed advertising criteria 52.

The distressed advertising criteria 52 is generated from a selected one of the different sets of advertisement information 26 offering a distressed advertising space 28 for sale. In this embodiment each of the sets 26 specify a requisite type of advertisement required such as a gardening advertisement, a sporting advertisement, a computing advertisement, a car advertisement and so forth. Furthermore the sets specify a particular size of advertisement in a particular principle colour and so forth. The requirements specified in the selected one of the different sets of advertisement information 26 at least partly the distressed advertising criteria 52.

Conversely the distressed advertising criteria 36 is generated from a particular one of the different sets of advertisement information 42 offering an corresponding advertisement 44 for use in distressed advertising. In this embodiment each of the sets of advertisement information 44 provide a specific type of advertisement and provide a principle colour used in the advertisement such as orange, purple, yellow and so forth.

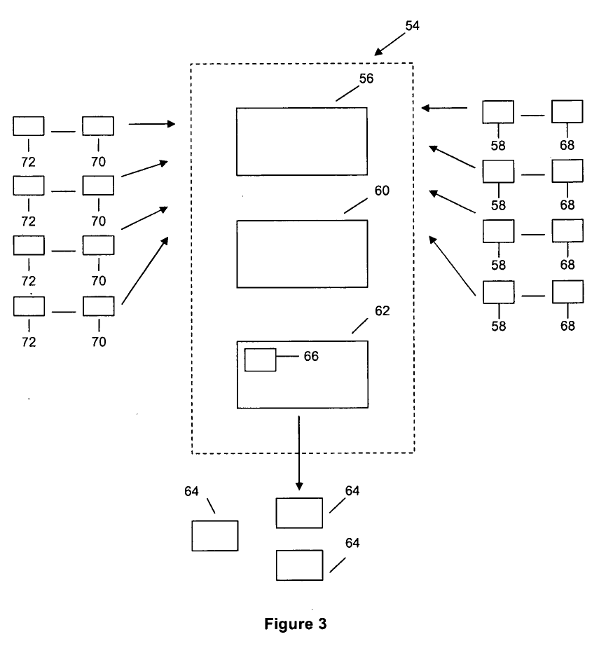

Referring to FIG. 3 there is shown a system 54 for coordinating information for use in advertising. The system is provided in accordance with a preferred embodiment of the invention and comprises receiving means 56 for receiving different sets of advertisement information 58 associated with the advertisements for distressed advertising space. The system 54 further includes storing means 60 for storing the sets of advertisement information 58 and searching means 62 for searching the stored sets of advertisement information to locate at the least one set 64 that meets with distressed advertising criteria 66

In this embodiment the different sets of advertisement information 58 each offer a different distressed advertising space 68 for sale and thereby are accordingly associated with advertisements for distressed advertising space. The receiving means 56 is further configured for receiving different sets of advertisement information 70 each offering an advertisement 72 for use in distressed advertising.

The system 54 is able to match particular distressed advertising spaces 68 for sale with one or more of the advertisements 72 as they become available by generating the distressed advertising criteria 66 from the advertisement information 70. A reversal of this process is also performed.

One notable benefit is that in this manner the ‘average’ person or small to medium enterprise is able to source distressed advertising space for sale. The payment made by the ‘average’ person or small to medium enterprise offering the advertisement occurs through the system 54 so as to avoid the entity offering the advertising space for sale having to chase payment. As such many providers of advertising space are able to access the system. The payment, in this embodiment, occurs online using an online credit card system.

It is envisaged that each of the sets of advertising information 58 each offering a different advertising space 68 for sale will have particular urgency indicators such that when the searching means 62 locates a plurality of sets 64, the sets 64 can be ranked in a particular order. Although the sale price may be used as an urgency indicator separate urgency indicators such as high medium and low are envisaged.

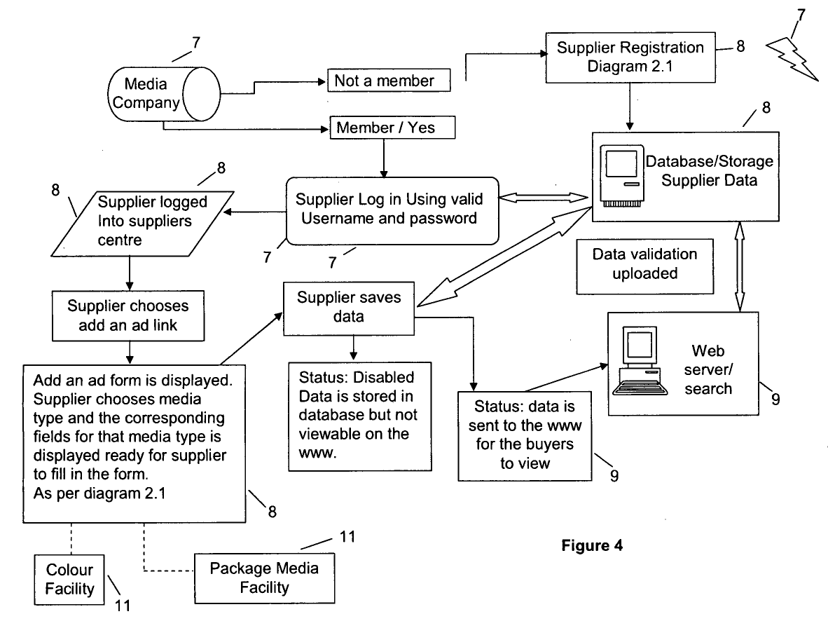

As illustrated in FIG. 4 the system 54 provides a web portal 74 which prompts the user for a login 75 and a password 77. When a media company 76, for example, accesses the portal 74 the media company 76 is prompted for the login and password using a secure login section. It is subsequently determined whether the media company 76 is member recorded in a database storage area 80 of the system 54. If the media company is not recorded as a member they are prompted at block 82 to apply for membership by filling in an online registration form. Once the media company 76 has provided all the requisite details and has been authenticated the details are stored in the database storage area 80.

In this regard it is to be appreciated that several entities such as agencies involved in the provision of advertising space may fulfill the role of the media company 76. Agency arrangements allow agencies to use the system without being required to pay on purchase as they have accounts with the suppliers already. They would purchase through the system and a commission cheque would be sent. As indicated above the advertisers will typically pay on purchase through an online credit card facility.

Referring to both FIGS. 3 and 4, once the media company 76 is verified the company 74 is provided access to a supplier's centre 84 at block 86 from which the company is able to upload sets of information such as sets 58 each offering a distressed advertising space for sale. In this way the media company 76 is able to access the supplier centre 84 to upload distressed advertising space details for advertising space that has been unsold prior to an initial deadline, for sale to buyers. This is shown at block 88 where the media company 76 enters details including the media type. In this embodiment a list of media types is provided for selection by the media company 76 including bill board media, magazine media, paper media, taxi media, other and so forth.

Advantageously at block 88 there is provided a method of prepopulation which includes prepopulating items for use in the set of advertisement information uploaded by the media company 76. By accessing the database storage area 80 containing statistical information, typical media types and colours are used to prepopulate the fields used at block 88 to receive the distressed advertising space details.

After a set of advertisement information 58 has been created the set is saved and made live at block 90, following which the set is made available for advertisers to buy and locate using a web search at block 92. Additionally once the set of information has been saved it is used to update the statistical data in the database storage area 80 for later use in prepopulation.

The system 54 has a search means in the form of a search engine having specialised search functions developed to enable members to navigate around the system and search for the appropriate media forum and advertising they require. The search engine is able to utilise Boolean operators or natural language or a selection of search criteria to produce the search results. The search engine provides at least one search criteria which may be utilised to limit or expand a search. The search criteria includes and is adapted to find results according to category, target market, price, media type, name of media publication/radio station/tv channel, campaign date, state, new/old listings, demographical information, ratings or any other useful search criteria.

The search engine provides a one click search box allowing members to search for advertising and media suppliers without having specific knowledge or industry language to do so. The search engine enables members to enter keywords, phrases, any kind of text into a box and to utilise the one click comprehensive search. Once the search is entered system will search through the entire database that houses all the advisement information of the advertisement space providers and advertisers to provide extensive details related to products, services, clientele, target markets, demographics and so forth. The system will then display all matching data.

The system also allows for structured specific searches for specific database fields such as demographics and target markets.

The system provides a plurality of sets of advertisement information for distressed advertising uploaded by the seller which in this embodiment comprises media companies and agencies. Each set of information includes details such as: the category, publication or company name (for example The Age or Channel 10), recommended retail price, discounted price, percentage of discount provided, campaign date, deadline date, written description of advertising for sale, for example full colour 2 page banner advertisement), state for campaign, target market and format or specifications required for the advertising.

It is considered that advertising space providers will be able to use the search engine to gain more leads to the media company from a greater reach and will have special benefit for regional media companies

The media company 76 is also able to access previous sets of information 58 offering distressed advertising space already uploaded into the system and to make changes. Changes able to be made include changing the requisite specifics of the advertising space such as size, colour and type or disabling the set of information such that it does not display. This involves changing the status of the set from live to disabled. In this embodiment the sets of information 58 are stored in an XML database system. Other database systems and distributed networks are envisaged.

The media company 76 is able to access the supplier centre 84 to view statistics that show how many times their advertisements have been viewed by advertisers. They can see how many alerts have been set that match their media type, or other details that match their registration details. In this manner the media company 76 is able to gauge whether their last minute distressed inventory of space is being viewed by potential buyers and whether they should make changes to entice buyers.

Thus it will be apparent that the system 54 provides a most advantageous solution for distressed advertising space which is currently sold via traditional methods such as by telephone or by person. It is thought that the system will be particularly advantageous for regional newspapers as potential advertisers often do not go past local traders.

Moreover, the system 54 is directed towards allowing publication companies/media suppliers to source distressed advertising in view of advertisement requirements. Conversely the system 54 advantageously allows a group of advertisement space purchasers to buy distressed advertising, for a wide variety of products and services, from publication companies/media suppliers for a comparatively low price in comparison to the likelihood of gaining advertising exposure.

In order to ensure that the system 54 attracts distressed advertising space the system includes means for controlling the sets of advertisement information 58 offering distressed advertising space 68 for sale, such that the amounts requested meet with a predetermined pricing schedule. The predetermined pricing schedule has set sale amounts for particular sized advertisements for particular media types.

Thus for an advertisement space that might typically be sold at $50 in a well know newspaper, the predetermined pricing schedule ensures that the advertisement is sold at no more than $15. In this manner the system 54 also embraces retail and discount advertising. Generally distressed advertising will provide for lower prices as advertisements for the advertising space offered will be in relatively high demand by the seller of the advertising space, due to time constraints

The system 54 includes means for searching membership information stored on the database 80 to determine the pricing schedule according to predetermined arrangements. In this arrangement controlling the amounts for sale includes prepopulating the data entry form such that amounts beyond a maximum cannot be entered. In other arrangements controlling the set of advertisement information includes modifying the set of advertisement information if the amount entered exceeds the maximum.

Additionally the system 54 can determine pricing schedules from various logins that can be specified based on industries or membership. This allows the system 54 to recognise different pricing schedules whereby a different price can be set based on certain access levels, or based on location.

Further provided in system 54 are option means 110. In this embodiment the option means 110 includes a module for providing the option of modifying a set of advertisement information offering a distressed advertisement space 68 to include a particular item such as a particular principal background colour. The system 54 may have a predetermined configuration whereby the when the option is selected the pricing schedule ensures that the maximum sale amount is lowered and that the media company 76 is charged a corresponding amount for selecting the option. Other arrangements which operate on advertisement size and so forth are envisaged. These include images, specialised display formats, priority listings, SMS notifications and target market listings. Each of these options is made available for an additional prescribed fee.

In this embodiment different types of outdoor media are advantageously offered, and as such the system 54 caters for bus shelters, billboards and taxi tops. Print media, radio media, and dynamic media such as television are also catered for.

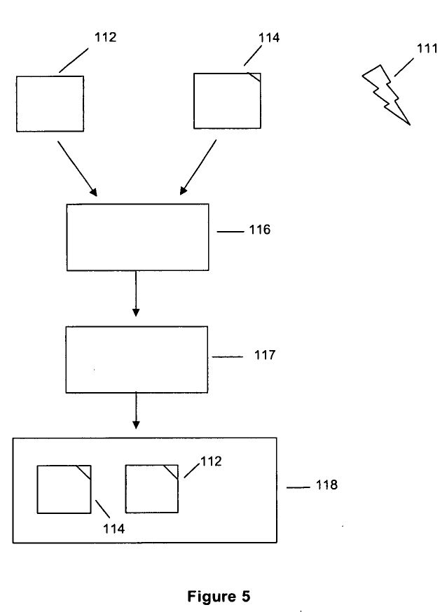

In addition, the system 54 includes as option means 111 allowing for these forms of media to be packaged into a discount package. It will be apparent that the option means 111 forms an embodiment in its own right. as shown in FIG. 5 the supplier saves a first set of advertisement information 112 for one type of media such as newspaper media and then saves a second set of data 114 for one of a distressed bus shelter, billboards or taxi top media. The supplier enters details in two separate sets.

In the system 54 at block 116 this includes receiving the first set of advertisement information 112, which in this example is taken to be associated with newspaper media. Following this the system 54 receives the second set of advertisement information 114, which in this example is taken to be associated with a bus shelter media. The system 54 at block 117 then provides the supplier with the option of forming a discounted package 118 including distressed advertising space for both the print media and the bus shelter media.

If selected, and subject to the second publication media being different to the first publication media, the system 54 forms a resultant set of advertisement information by combining the first set of advertisement information 112 and the second set of advertisement information 114. A sale amount is determined according to a pricing schedule, the sale amount being discounted given that the first publication media is different to the second publication media.

This arrangement is particularly advantageous as presently media companies do not offer discounted packages to be bought and sold online. By enabling sellers to sell discounted packages online, will inturn enable sellers to generate new leads. The system can cater for all media types and for combining multiple media types into a package online with the option of including production costs.

The functionality is provided in the system 54 by a package module allowing the supplier to choose which ads they would like to package together. The system 54 shows the main headings for each advertisement and the total bundled price. The supplier is further provided with the option of further discounting the price according to the pricing schedule when the package is displayed.

Furthermore with some media types, such as radio, the advertising space supplier is provided with the functionality to add into the package via the system the cost of production services. This can either be provided as an option to the buyer or be part of the complete package.

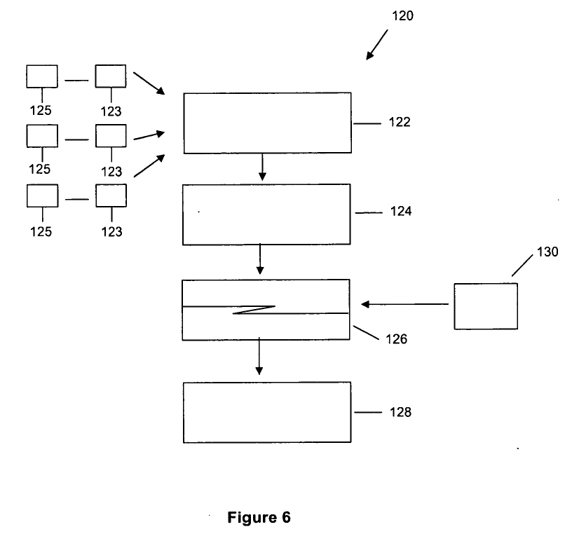

In an embodiment shown in FIG. 6 a method 120 is provided which at block 122 includes receiving sets of advertisement information 123 associated with advertisements for advertising space 125 and at block 124 includes storing the sets of advertisement information. More specifically the method 120 involves controlling, at block 126, the input of advertising criteria 130 to specify a search selected from a group specifying at least a national or international based search. After this the method 120 at block 128 involves searching the stored sets of advertisement information to locate at least one set that meets with the advertising criteria.

In this manner the system 54 advantageously operates on a national and/or an international basis to provide the ability to source available distressed advertising space. The system 54 provides international search capabilities with comprehensive searching that enables members to search for media companies offering distressed advertising space that matches desired criteria.

Advantageously the algorithms used within the search enable variables to be searched for from one search screen providing a one stop directory for everything related to advertising. The system 54 includes a mail centre using which an advertisement space provider or and advertiser can make an introductory enquiry.

In the suppliers centre 84 there is provided the ability to add an offer for advertisement, an advertisement, change an offer, view past offers; view offer statistics, view industry news on advertising sales and trends and take part in a specific forums including seller and buyer forums. Pod cast technology can advantageously be used through the supplier's centre 84 and the web portal 74. It is considered that interest will be fostered by the provision of industry news, articles, and forums allowing members to send queries to staff on advertising in combination with online forums, for members to swap ideas or questions.

In addition, new tools for members to use for advertising or marketing will be provided along with downloads of various freeware utilities related to advertising. Online tutorials for businesses to do online or listen via pod cast are envisaged.

In addition to pod casting facilities for online tutorials the technology is used to stream industry news and articles and to stream advertisements.

The seller and buyer forums provide forums for members to share ideas and questions and a blog for industry specialists to post up to date information and in which members can respond. These forums and blogs can be subscribed to and associated via other online systems. In addition online newsletters and journals are provided that are updated regularly and are accessible to members to read.

The supplier's centre 84 is password protected and has the facility to allow a member to change and add membership details, view accounts, access a mail centre for enquiries from buyers and add or remove publication or media types provided.

Furthermore the suppliers' centre 84 provides the ability for the supplier to perform a reverse search in which the supplier types in a figure into a reverse search field following which the system matches prices and display members willing to purchase space at or above amount entered. In the arrangement different sets of advertisement information each offering a different advertisement for use in distressed advertising are received and stored, each including an associated sale amount. This enables subsequent searching according to distressed advertising criteria specifying a limitation on the associated sale amounts.

The distressed advertising criteria may include a price per publication or media type that buyers are willing to spend. This may for example be $15 per column with a maximum number of columns for an advertisement in a well known newspaper publication. This information is set by the buyers of the advertising space and is stored in the database 80. Sellers are then able to access the database 80 to see what rates buyers are willing to pay for their stock and if they are happy to accept those rates can contact the buyers.

Advantageously the system 54 has configuration of means arranged to enable for anonymous email contact or contact via telecommunication networks including SMS systems to inform the buyers and enable them to purchase distressed advertising space at the amount proposed.

In the present arrangement and in the event that a supplier wants to sell the space for the specifications displayed he or she is able to click on a link, which subsequently takes the supplier to a page in which he or she would then fill in the details. After this, a reference code is issued by the system 54 and information is sent to the advertiser.

Of particular reference to distressed advertising is that the advertiser has a set time provided for accepting the advertisement space offered. If the advertiser wishes to purchase the advertisement space he or she would have to click buy on the message and go through a purchase procedure within a set time provided. The set time is determined by the advertisement space supplier and may for example be a 30 minute deadline, a 60 minute deadline, a 12 hour deadline, or a 2 day deadline and so forth.

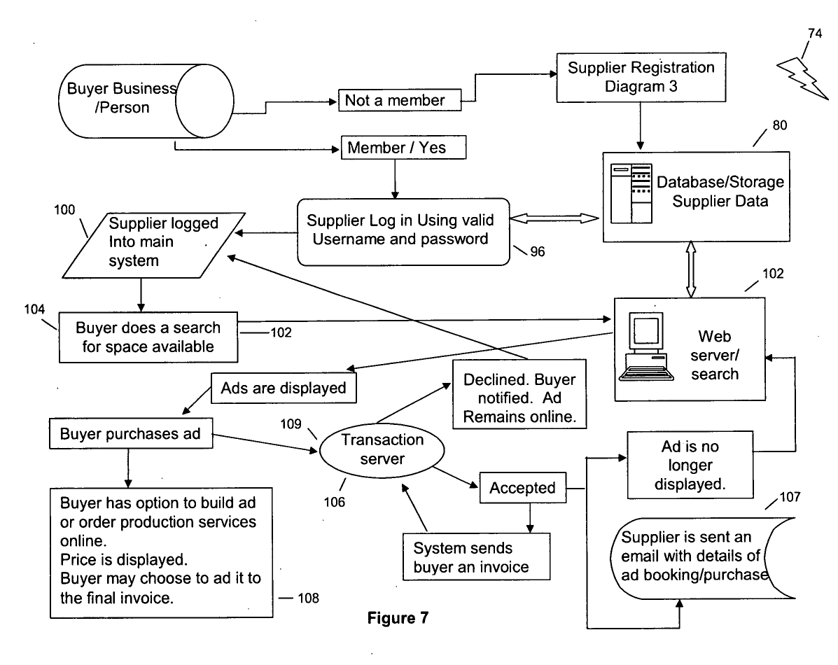

Referring to FIG. 7 there is shown an advertiser advertiser 94 using the web portal 74 to upload advertisements for use in distressed advertising. To perform this action the advertiser 94 logs onto the web portal 74. The advertiser 94 is then prompted for a login and a password at block 96. If the advertiser 94 is not a member recorded in the database storage area 80 then the advertiser 94 is prompted to register using an online form. Once the credentials of the advertiser 94 have been authenticated details of the advertiser 94 are stored in the database storage area 80 at block 98.

At block 100 the advertiser 94 is provided access to an advertiser's centre 100 from which the advertiser 94 is able to upload advertisement details for the provision of an advertisement for use in distressed advertising space. The advertiser 94 performs this task by clicking on a button and then inserting the details into an online form. As before the fields of the form are prepopulated using statistical information saved in the database storage area 80.

In the centre 100 the advertiser 94 can set a rate he or she are willing to pay for advertising space. A newspaper publication would state the price per column, maximum spend, page and position. This information is stored within the database 80. The system 54 then accesses the database to determine if any distressed advertising suppliers having space available for the associated advertisement.

FIG. 7 shows a searching option 102 available to the advertiser 94. With the searching option 102 the advertiser 94 enters in desired advertising criteria relating to distressed advertising. This is performed at block 104. Previously with the searching option a number of sets of advertisement information each offering a different advertising space for sale have been received and these are stored in the database 80. This allows the searching option 102 to subsequently search the stored sets of advertisement information each offering a different advertisement space for sale to locate at least one set that meets the distressed advertising criteria associated with the advertisement.

In this embodiment the desired advertising criteria is entered as part of the uploaded set of advertisement information and includes criteria specifying colour, size, and type.

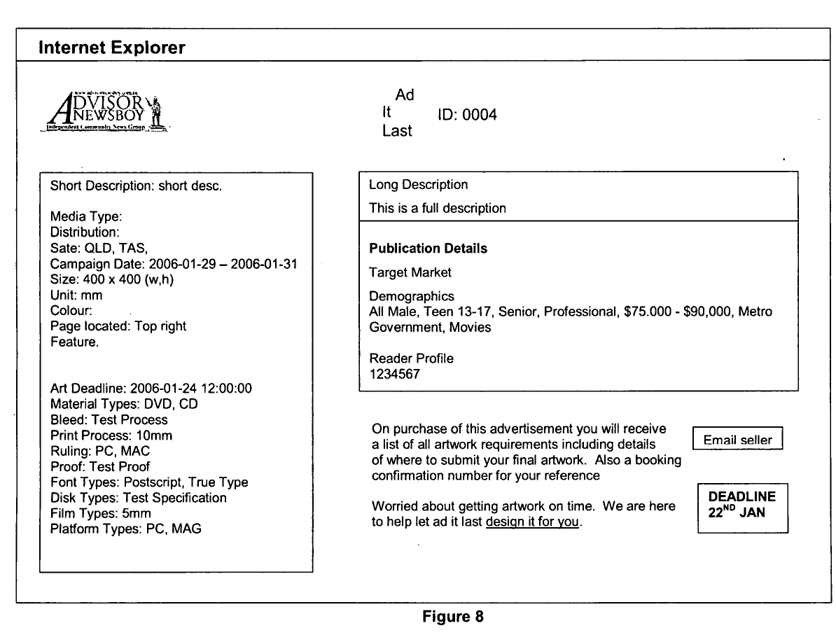

After this the advertiser 94 is presented with the option of buying at least one advertisement space located by the search option 102. At block 106 a transaction server is employed to forward the set of advertisement information to the media company offering the distressed advertisement space selected by the buyer. If accepted the advertisement space is no longer offered for sale and the system sends the buyer an invoice. In this embodiment the invoice requires immediate payment by credit card at block 109 to finalise the transaction after which the supplier is sent an email confirming payment. Alternate purchasing systems may be used. In one embodiment the payment may be partly refunded if the advertisement does not meet agreed criteria. A web portal screen print out is shown in FIG. 8.

Although not shown in FIG. 7 the system 54 includes a limitation whereby the advertiser 94 is only able to search for advertisement space having a payment amount meeting with a pricing schedule. In this manner the system controls a set of advertisement information entered by the advertiser 94, such that an amount offered for the distressed advertising meets with a pricing schedule.

With a bundled package the advertiser is able to click on an associated link to get individual information regarding each advertisement space offered in the bundled package. The advertiser are able to contact the advertisement space provider anonymously with an offer for the bundles package, if the offer is accepted, the buyer is then able to purchase the bundled package.

In the advertisers centre 100 the advertiser is able to type any word into the search box from which the system 54 will then access the database 80. Searchable database fields in the database 80 include media company registrations, packages and all advertisements tagged to be searchable. In this manner this enables advertisers to use any keywords to search for relative data for purchasing advertising space. They can use a single keyword search or they can narrow their search down via an advanced search. By utilising specific fields within the database 80 and programming it into search databases the system 54 enables comprehensive searching for the entire website on a national and international basis.

There is also facilitated an auction environment in which an auction is initiated and there are received different sets of advertisement information associated with advertisements for distressed advertising space, each set including an associated sale amount. In the auction a selection process is undertaken in which one of the sets of advertisement information is selected based on the associated sale amounts.

The system caters for two types of auctions. The first is where the sets of advertisement information each offer each a different advertisement at a particular sale amount. That is the buyers of space make offers for a particular distressed advertising space. The second is where the sets of advertisement information each offer a different advertising space for sale at a particular amount That is, the sellers of space make offers for a particular advertisement offered for use in the advertising.

At block 108 the advertiser is presented with the option of building an advertisement. This option, as with other options of background colour, involves an extra cost. Once the option has been selected the system 54 will tells the buyer how much it will cost to design the advertisement for the space they purchased. The building system provided at block 108 provides design services online for quick turn around. Presently there are no systems that provide the ability to buy, build and send advertising online in one session.

The present system allows for an advertiser to buy, build, upload and/or distribute banner advertisements online in one session. This feature enabling an advertiser to buy, build, upload and/or distribute banner advertisements is available for other forms of media also, for example it has particular application to print media. In the system a set of advertisement information is received that is associated with an advertisement for banner advertising space. After this the set is associated with a respective banner advertising space and a respective banner advertisement. The system enables buyers to purchase banner advertisements, choose to build them online or use a ready made banner ad that can be added to the system.

The banner building system allows members to access a program that takes them through the process of building an online banner advertisement. They are able to choose to use a static template or an animated banner template. In order to achieve this the system houses a collection of custom coded banner templates developed especially as a dynamic system in which the code can be changed by the member from a user friendly interface which requires no programming detail. This is particularly advantageous.

The system allows the advertised to upload their logo, create certain animated or flash scenes and add content and sound. Once they have created a banner advertisement they are able to save it and send it directly to the seller via the system. Alternatively they are able to save it in the members centre to use at a later date or for other purposes. The banner building system can be used by members at anytime, not only when they purchase advertising. There is a cost associated with the system for use.

It is considered that the banner system is most advantageous as a buyer can either build a banner ad or upload an existing one. Based on how many click throughs or packages they bought they can then upload the banner into the system which then slots their banner ad into one or more websites and automates the view time.

As described, one notable feature of the system, is that once an offer for advertisement space has been selected, the system adds up the cost to design an advertisement using a predetermined calculation method programmed within the system. The predefined calculation method operates on variables including the size of the advertisement and the cost per cm. After this the buyer is shown the cost and is provided with the option of adding the cost to the final invoice so as to be able to access a build system at block 108.

The build system after the selection of an offer of advertisement space; and the offer of a design service to build an advertisement operates to ensure that the advertisement will be prepared within a predetermined time frame. The user is provided with two options the first being to build the advertisement online themselves or to engage design services to perform this task on their behalf within a predetermined time frame.

With the selection of the first option and with the advertiser, that is the buyer, already logged into the system the advertiser is able to access various templates that are sized according the advertisement purchased. The templates enable the advertiser to manipulate the text, images, colour and so forth. The advertiser can upload their logo and change the text. The advertisement can be built within minutes and then the advertiser can buy, build and deliver their advertisement to the advertisement space supplier all online straight away. The templates may be provided by a third party program having an automated a delivery service to deliver the ad straight to the media company.

The second option is targeted to advertisements that have been purchased for glossy high end magazines as most buyers would prefer a graphic artist to produce individual designs for these types of advertisement space. The second option is preferably utilises one of a number of design service providers. The selected provider is paid by the advertiser an instance where the buyer does not have the advertising content pre-prepared and the seller requires finalised advertising content.

The design service is adapted to have a rapid turnaround between 24-48 hours such that, when a customer purchases distressed advertising they are able to utilise a designer who can complete the design work by the closing deadline.

This alleviates the problem of individuals and/or companies not being able to purchase distressed advertising simply because they would not be ready by the publication deadline. The design service will be able to be purchased and/or engaged online via a built-in facility on the website whereby a potential buyer will be able to upload or provide a description of all the details and design online and have the information directly submitted to the designer.

The contact details of the designer are made available such that the buyer can speak to them directly. Alternatively, if the seller is able to organise for the design to be completed, a buyer can request this service at the time of purchasing the distressed advertising.

In some instances the advertiser will upload content, images, logos via the system to the designer. The designer can then design the advertisement and send it to the advertiser via the system and email for approval. The system will have an approval system where a member can view the design and choose to make changes or approve the advertisement. This would then be sent back to the designer.

The prepared advertisements they are digitally delivered using third party tools in the correct format to the media companies ready for print or distribution

It is to be appreciated that the embodiment is especially advantageous in that there is provided a method comprising creating a session and arranging for the purchase of advertising space; design of an advertisement and supply of the designed advertisement within a predetermined time frame, said arranging occurring within the session.

Currently media companies, especially print media can have an advertiser pull an ad out at the very last minute. For example someone might pull a full page advertisement out five hours prior to print. In this case the media company these days would have to try to fill it with house ads or editorials which are difficult. The embodiment provides a solution whereby distressed advertising space can be readily filled.

Referring to FIG. 6 there is shown an alert system 120 according to a preferred embodiment of the invention. The alert system allows participants to set alerts for specific types of advertisements or advertisement space offered in the system. The alert system operates automatically to match criteria and information via various alert methods. On an alert seller and buyers can be notified by email, SMS and other telecommunications systems. The statistics gathered by the system integrates with the alert system whereby the statistics gathered will show advertisers and advertisement space suppliers that they are being searched for or are having alerts set for.

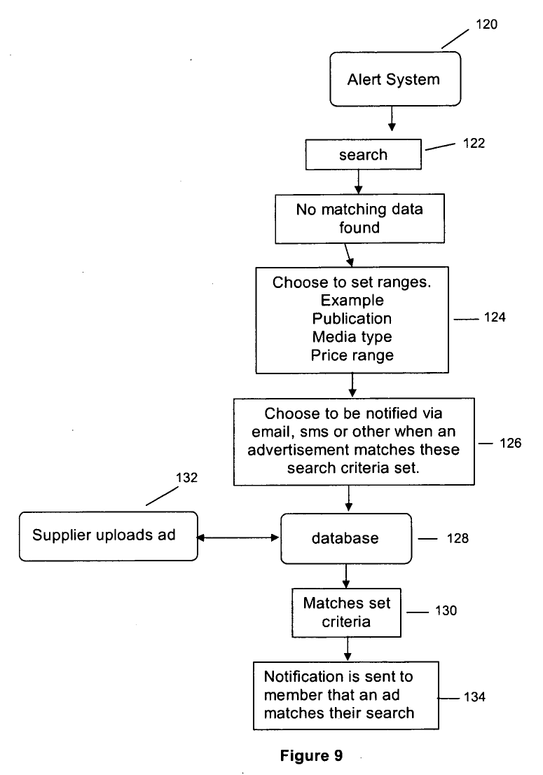

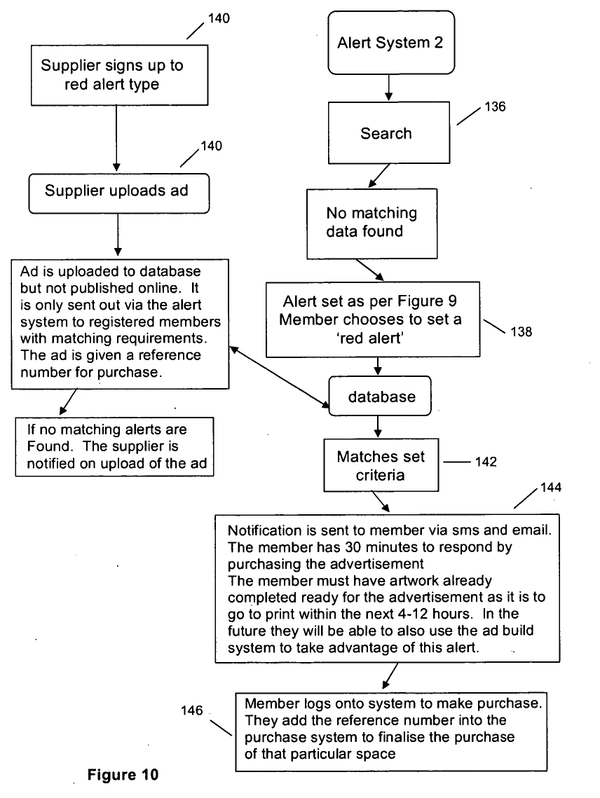

In the embodiment and also illustrated in FIG. 9, an advertiser performs a search to located distressed advertising space at block 122. The search returns no hits and the advertiser reacts by setting an alert to match requirements set using the alert system at block 124. The advertiser chooses to be alerted via email and SMS when a supplier uploads an offer of an advertisement space that matches match requirements as shown at block 126. In the arrangement different sets of advertisement information each offering a different advertising space for sale are received and stored. Following this the system searches the stored sets of advertisement information each offering a different advertisement space for sale at block 128 to locate at least one set that meets with the distressed advertising criteria 130 set by the advertiser. This occurs after a number of spaces have been made available at block 132. After this at block 134 an alert is sent to the advertiser on a set being located that meets with the distressed advertising criteria.

This forms a first alert type shown in FIG. 9 in which members can do a search using the search or the advanced search and, if no ads match their requirements, can set an alert via the system. They can choose to be alerted via email, sms or both. When a supplier uploads an ad space that matches the alert the buyer is notified. In another alert type when an advertiser uploads an advertisement an advertisement space supplier supplying a space matching predefined criteria is notified.

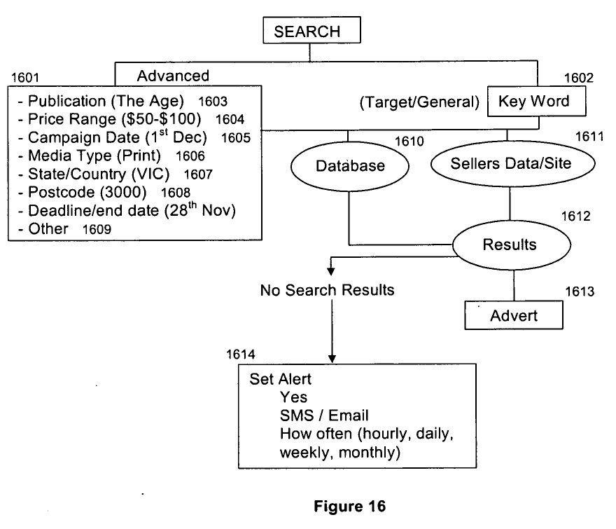

An example of a search 122 of FIG. 9 may be as shown in FIG. 16. The search may use an advanced menu option 1601 or a key word option 1602. In the advanced option 1601, the search may be conducted using a preconfigured menu, such as publication 1603, price range 1604, campaign date 1605, media type 1606, territory 1607, postcode 1608, deadline or end date 1609, or other criteria. The publication 1603 may be the name of a particular media type, such as a magazine, the price range 1604 may define the price that the user is willing to pay on an advertisement and is used to locate any advertisements in the database within that price range, campaign date 1605 is the date of that the media is launched or run, media type 1606 is for example, print, radio, etc, territory 1607 defines a geographical region, postcode 1608 may define also a zip or other similar coding associated with a region, and deadline date 1609 is the date at which the advertisement will no longer be available for use.

With regard to the keyword option 1602, the user can simply define a word and/or any combination of words and/or indicia.

Following this, a search is preformed in the database 1610 of the present invention and/or any other related database 1611. If the result 1612 of the search locates an advertisement 1613 that matches the search criteria, then the user is directed to that advertisement. If the search does not find an advertisement, then an alert 1614 may be set. The alert may comprise:
the manner in which the alert is to be provided to the user, such as SMS or email, or other medium,
frequency, which defines how often the search is to be repeated in order to once again check to see if there is available an advertisement that matches the user's criteria,
keyword when used or input into the database, and/or
other predetermined criteria, for example as defined by the user.

A second alert system shown in FIG. 10. In this alert system, a user may search for advertisement space at block 136 according to a search method as herein disclosed and/or according to any other search method. If the user does not return a desired result, the user may subscribe to a second (red) alert type system at block 138. The second alert may alternatively be subscribed to at any time. With this second alert, a supplier may signup to the second alert system at block 140 and unload an advertisement and/or a related advertising space at block 141. The advertisement is uploaded to the database but not published online. The advertisement information is sent via the alert system 145 to registered users with matching requirements. The advertisement is given a reference number or some other form of identification. Preferably, the supplier of the advertisement is notified 147 at or soon after uploading the advertisement if there are no current alerts matching the advertisement.

With regard to the user, the second alert may be selected 138. The user's alert is stored in the database, and a search 142 is conducted to see if there are any advertisements which match the search criteria. The user will be alerted 144 to the presence of the supplier's offer. The user/advertiser is informed that in order to accept the offer, they will have to reply within a preset time, for example a 30 minute time period, to purchase the advertisement. Furthermore, after accepting to purchase the advertising space at block 146 the advertiser is required also have the advertisement ready to go within 4 to 12 or a couple of hours to make the deadline.

In this alert type, the supplier of the space instead of uploading the advertisement space into the system by going online, they may choose to upload the advertisement space and/or details of the advertising space into an alert database which will alert the seller to subscribing members who match the requirements of the advertisement space. The details of the advertisement space are then transmitted via email and sms to those members who have chosen to receive this type of alert and who match the requirements.

After accepting an offer of an advertisement or advertisement space the user logs onto finalise the purchase using a reference code supplied. This reference code is used by the system to finalise the transaction, and may also be used to generate billing and or other required information/procedures. Alternatively an email or sms based finalisation process may be employed.

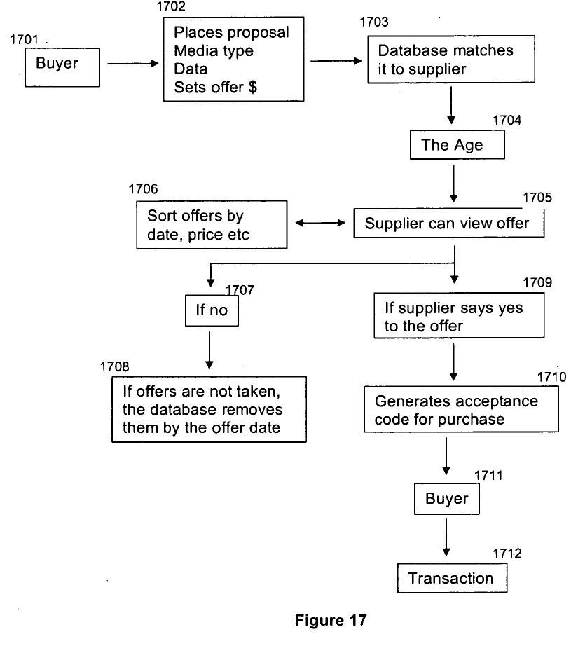

A further, third alert system may also be provided. An embodiment of this third alert system is provided in FIG. 17. In this embodiment, the user or buyer of the advertising space alerts a supplier of advertising space that they wish to purchase advertising space. Turning to FIG. 17, the buyer 1701 provides advertising criteria 1702, such as media type, date, price, etc, and forwards this 1703, preferably via the database of the present invention to a supplier 1704. The supplier reviews the offers 1705 and may use a searching criteria 1706. If the supplier decides to refuse the offer from the buyer, this is then recorded in the database, and if there are no acceptances provided by supplier(s), then the offer is removed 1708 from the database. If, on the other hand, the supplier accepts the offer, 1709, an acceptance or other reference code is generated 1710, the buyer is informed 1711 and a transaction can take place 1712.

Other alert types (not shown) involve a set price alert for advertisers when offers of space are made below a set price for a specific advertisement type and for suppliers when an advertisement is offered to fill space at a purchase price above a set price.

As part of the system there is provided a further advertising method. Using the method it is possible to build a campaign using a wizard. The method involves providing a series of questions using various forms through which the advertiser enters information through a number of fields. These fields request information including a written description of the campaign, the objectives, the target markets, the estimated revenue, the estimate budgets and so forth. During the process the wizard provides examples and descriptions which are particularly advantageous. The questions are provided in a sequential series and the advertiser is provided with the opportunity of using several calculators including a return on investment calculator described below. Once the information regarding the campaign has been generated the advertiser is provided access to a timeline system using which the advertiser is able to set alerts over the duration of the campaign, and search for advertisement space availability or packages that match their requirements and timelines.

Furthermore the timeline system provides a calendar and reminder system using which the advertiser is able to set notifications including sms and email notifications prior to calendar deadlines for ad buying, design work or delivery of an advertisement. Once the campaign design has been completed it can be emailed, stored in their members section or printed out. The advertiser is able to choose various formats in which the campaign can be saved. The member can also add the calendar for notifications to a toolbar notification system.

The series of question include questions regarding company details, name and so forth. A first step comprises showing the advertiser the title of the first section of a series for questions, for example the Executive Summary. During the first step and as indicated the advertiser is able to view a detailed description of what the purpose of the Executive Summary is and is provided with a helpful example. In this arrangement the advertiser types directly into the space allocated and has a range of tools made available to assist them with formatting the document.

After completing the Executive Summary the advertiser moves onto the next section by clicking a button. The advertiser is able to save the campaign as they go so that if they do not finish the entire plan in one sitting they are able to save it to their members storage centre and can open it later to continue. On completion of the campaign the system will create a professional, formatted marketing plan optionally in a PDF or MSWORD format

During the creation of the marketing plan the system pulls keywords which we can be used for targeted advertising for certain members whilst they are searching the website or working on their campaign/marketing plan. When a member is writing their plan or typing certain keywords the system is able to recognise the word and send to the page an advertisement targeted to those keywords. The portal system will be able to pick up keywords from the wizard as a member is writing their plan, it would then target specific advertising to that page whilst the member is utilising the wizard system.

The system gathers statistics and logs user activity for use in analysing trends. The forms of statistics gathered includes buyers information, sellers information, median advertisement information, demographic information, sales/bids/conversions records, search data site traffic data, media publisher data ISP records, banking transaction records, advertising content, enquiry data and message centre records. With online advertisements including banner advertisements further statics gathered include how many people view it, how many click throughs and conversion statistics.

In this arrangement there is an associated database that is be separated from or integrated with the actual portal server, containing the various statistical forms of information gathered including such as demographical information, ratings and various other information that can be obtained by a research group or software program which provides a user with statistics beneficial to a publication or media company in identifying and monitoring target markets.

It is envisaged that means for providing statistical information will be adapted to record and evaluate and reproduce information provided on the website and actions conducted through the website. For example, it may be possible to determine which search terms and/or categories are most searched, the percentage of distressed media purchased and a plurality of other vital information and/or statistics which would be beneficial to publication and/or media companies to indicate various existing or ongoing trends in the marketplace.

The results can then be reproduced in tabulated, plot, or any other suitable form which provides easy and quick access to relevant information. This information will preferably be on-sold to companies who wish to have access to this data for an additional cost. As such, the method and system for buying and selling distressed advertising can also be used as a valuable resource tool for individuals and/or businesses. It also provides an additional means of marketing for an individual and/or business to provide exposure to a wide demographic range. It is envisaged that the system may also provide online marketing tools which enable an individual and/or business to further utilise the system as a resource tool, with assistance in creating business and marketing plans.

The system provides means which enables a user to obtain various statistics that are beneficial to a publication or media company. It is envisaged that the means for providing statistical information will be adapted to record and evaluate and reproduce information provided on the website and actions conducted through the website. For example, it may be possible to determine which search terms and/or categories are most searched, the percentage of distressed media purchased and a plurality of other vital information and/or statistics which would be beneficial to publication and/or media companies to indicate various existing or ongoing trends in the marketplace. The results may be reproduced in tabulated, plot, or any other suitable form which provides easy and quick access to relevant information. It is envisaged that this information will be on-sold to companies who wish to have access to this data.

In a particularly advantageous feature, if certain advertisements or advertisement spaces are continually not selected they are published in a magazine to entice other members. This involves receiving different sets of advertisement information associated with advertisements for distressed advertising space and storing those sets. The sets of sets of advertisement information are searched to locate at least one set that meets with distressed advertising criteria. After this particular sets of advertisement information are highlighted when then said particular sets of advertisement information repetitively do not meet distressed advertising criteria. This is performed by gathering related statistics as described above.

In this arrangement sets of advertisement information are highlighted by providing an online publication directing readers to said particular sets and by providing an online newsletter and an e-magazine which contains the advertisements.

The use of website form fields to receive the sets of advertisement information is supplemented with an inbuilt spread sheet uploading facility. The system includes supplier spreadsheet templates that are preset with all the fields required. The spreadsheet templates can be downloaded to enable the supplier create a spreadsheet and enter each item many times and once the spreadsheet is ready to upload the supplier can log into the website and choose to upload the spreadsheet. Following this the system collects the data from the spreadsheet and stores each item into corresponding fields in the database. Once these fields have been matched the advertisement information is saved into the database and where the supplier has chosen to send the advertisements live they will be available for display on the website for purchase.

The system further provides charity features in which suppliers of advertising space have the option, via fields, when adding an offer of advertising space to the system, to donate the advertisement to a charity in the event it is unsold within a particular time frame. Furthermore, if advertising isn't sold the system will offer the ability to donate advertising to a charity. Either the user/advertisement supplier can choose the charity as a default or the system may include a list of predetermined charities from which the selection is made in a predetermined or a random manner. When a supplier adds advertisement information they will have the option to choose if they would like to donate to a charity in the case it does not selling.

When the advertisement is not sold, the supplier is sent a notice within the system with a list of charities that have been obtained from the database. The supplier is able to choose from any of the charities one or more charities that they wish to donate the advertisement to. The system then notifies the charity via an email that they have received the space from the supplier. They then log into the system as a member and will be provided an added link in the members section allowing them to accept or decline the offer of the donated space. On acceptance of the offer the supplier is notified that the space is taken in the same manner that is given for all buyers. The Charity can then choose to use the same resources allocated within the system for production and design if they so choose. If more than one charity is selected, the first charity to respond is provided with the advertising space and the other charities are accordingly notified that the space has been taken.

In one embodiment, a set of advertisement information associated with advertisements for advertising space is received and stored along with a number of different received sets of advertisement information. Before receiving the set of information there is provided an option of including a particular item associated with a donation to community conscious party, with the option comprising letting the community conscious party to use the advertisement space, if the advertisement space is not sold within a predetermined time period.

The system accordingly provides a community conscious company business model in which suppliers can choose to let a charity use an advertisement space if the space does not sell. They can either choose the charity or let the system decide. The system may decide by choosing a charity randomly selected from a list of charities that have been approved.

There is also provided a sponsorship system in which organisations, companies, products and businesses are able to offer sponsorship as a means to advertise. The system allows these companies to upload their sponsorship offers online and have access to a wide range of potential sponsors.

In the system a set of sponsorship information associated with a sponsorship is received through a web portal and a sponsorship offered based on the set of sponsorship information received.

The sponsorship made available on the web portal does not have to be prepurchased. The system allows the advertiser to apply to sponsor on some occasions and in this instance the system would send all the data to the accepting participant so that contact can be made between the participant and the sponsor. The system charges a commission on the amount received or a fee for advertising of the sponsorship.

In this manner sponsorship seekers do not have to chase potential sponsors via telephone, email, or other sales techniques which are time consuming. The system also enables buyers to search for sponsorship opportunities, the same as they would for all other advertising. A charity may sponsor a participant who then returns a portion to the charity. Nevertheless the sponsorship system of the embodiment not just for charities but will also be a place for sponsorship of sporting teams, national and local events and so forth.

One notable facility is a toolbar or desktop item which can be downloaded to notify a user of various information relating to distressed advertisements or distressed advertising space offered on the web portal.

Another facility provided is a return on investment calculator. Using the calculator a member can click on the calculator to take them to an interface that allows them to enter data to extract a figure which shows them how many sales or a figure they need to return to make a profit or break even from purchasing certain advertisements, or to run a campaign.

The calculator takes an investment cost, an average cost of a sale, the amount of time the advertisement will be viewed, the enquiries expected to follow and so forth. Using the calculator the member can do a quick calculation prior to purchasing. It is thought that the calculator will be particularly advantageous for small businesses that are not sure on how to advertise and what their return on investment should be.

Another feature provided is a financing module for small businesses who do not have a lot of cash at their disposal. In the event that a great deal comes available on the system, such as a billboard for half price from $20,000 to $10,000 the financing feature will allow members to find finance.

Further embodiments of the invention may be provided using SMS/WAP/3 technology to enable buyers and sellers to access and utilise the system via a mobile device. They may also be provided a phone order service which will allow a buyer to have a representative conduct a search and report back to them if they do not have internet access or if they do not have time to search themselves.

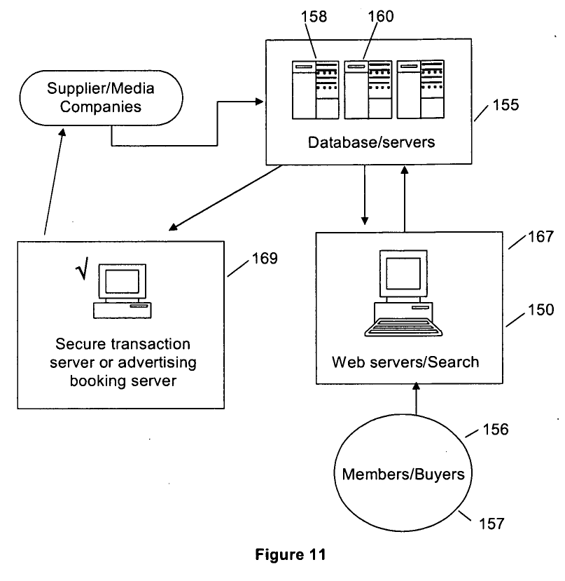

In an embodiment shown in FIG. 11, the invention provides a system for offering and selling distressed advertising which has provided a website 150 which is adapted to sell distressed advertising to targeted consumers such as marketers, advertising buyers or other professionals wishing to purchase advertising. In the embodiment of the invention the advertising is offered directly to the customer at a discounted rate and is only available and/or applicable to distressed or last minute unsold advertising. Thus the invention provides a system for offering and selling distressed advertising (last minute or unsold advertising space) in an online environment which is adapted to offer and sell distressed advertising to targeted consumers such as marketers, advertising buyers or other individuals or businesses wishing to purchase distressed advertising at a discounted rate.

The system has provided a web server 150 to which a plurality of buyers 2 and sellers 3 can be connected over an online distributed communication network 4 such as the internet or the like. The server 150 can be any standard computer system made from any suitable computer manufacturer such as IBM, Hewlett-Packard, Dell, Compaq, Acer or the like.

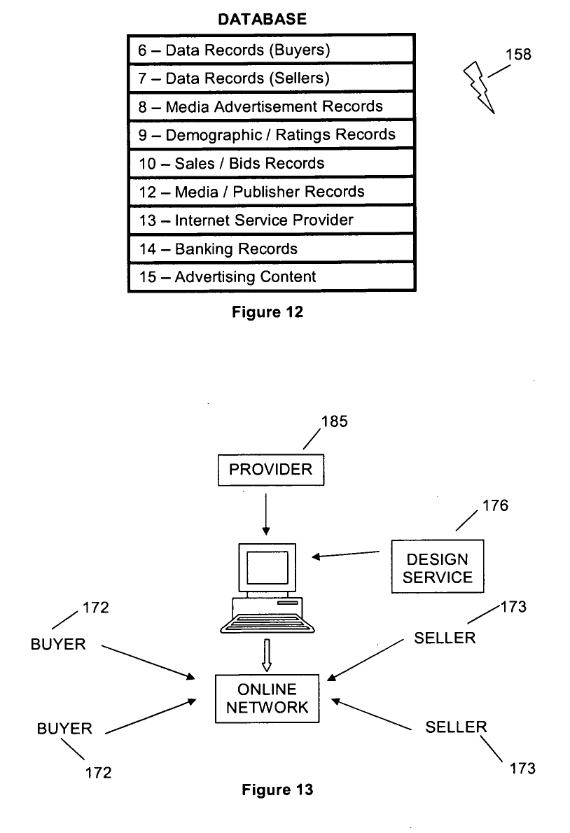

The server of the invention has provided at least one database 155. A first database 158 is adapted to store details of members who subscribe and wish to obtain full access to the system. Membership is provided as a means of maintaining a targeted audience for the invention such as marketers, advertising buyers and other professionals. The database 158 is adapted to collect and store information about members, including data records for buyers 156 and sellers 157, such as contact details, contract records and other necessary information. The database, as illustrated in FIG. 12 may also contain median advertisement records 8, demographical and/or ratings records 9, buyer's sales or bids records 10, media/publisher records 12, internet service provider records 13, banking records 14 and advertising content 15 which is uploaded by a buyer 2 or designer. The database may be used to authorise a person to purchase or sell median advertising or for statistical purposes, subject to privacy laws. It is envisaged that a user will be able to update their details at any given time.

The system of the invention has a database 160 associated with the website which is adapted to store details of members who wish to obtain full access to the website. Membership is provided as a means of maintaining a targeted audience for the invention such as marketers, advertising buyers and other professionals. The database is adapted to collect and store information about members, including buyers and sellers, such as contact details and other necessary information. The database may be used to authorise a person to purchase of sell median advertising or for statistical purposes, subject to privacy laws. It is envisaged that a user will be able to update their details at any given time.

The system has provided an online interactive interface accessible through a user's computer in the form of a website 167 which enables a user to view, retrieve and store data on the database(s) 155 of the server 150. The website 167 may have provided a plurality of web pages which are interconnected or interlinked and can be accessed via links provided on the home page and/or other pages within the website. Each web page may be provided with at least one category and/or subheading to facilitate a user in navigating their way around the area and finding the correct information or location they need. In a preferred embodiment, the website may have the following basic menu breakdown structure:

The system has provided a payment means 169 to enable a buyer to purchase an ad and/or a seller to provide payment for use of the system. The payment means is preferably in the form of an e-commerce platform with high level security which is adapted to enable all transactions to be accepted and processed internally via an online environment in a secure manner such that, handling between buyers 2 and sellers 3 is eliminated. In a preferred embodiment of the invention payment must be made in advance at the time of the transaction in order for the advertising to be subsequently sold or provided to the customer. It is envisaged that payments may be accepted and processed directly through the provider or via an approved third party. If a user requires financial assistance it is possible for the user to have an account with the provider which enables them to be invoiced and provide payment at a later date so that they are not disadvantaged from using the system.

The invention may have provided e-commerce facilities with high level security which are adapted to enable all transactions to be accepted and processed internally via the website in a secure environment such that, handling between buyers and sellers is eliminated. However, in an alternate embodiment, a user may be able to have an account with the provider which enables them to be invoiced and provide payment at a later date. In a preferred embodiment of the invention payment must be made in advance at the time of the transaction in order for the advertising to be subsequently sold or provided to the customer. It is envisaged that payments be accepted and processed directly through the provider or via an approved third party.

A method of an embodiment of the invention shown in FIG. 13 involves a buyer 172 registering the details to become a member and gain full access to the online distressed advertising system and services provided. This can be done via the online portal/interface accessible through a buyer's 172 computer via the internet. Once a buyer 172 has provided their contact details and other necessary information, they are issued with a unique user name and password which they can utilise to log onto the system or server 150 and have access to the services and facilities available. Membership is divided into buyer's and seller's membership areas such that members may only have access to the appropriate sections of the website. It also provides them with access to their own personal member's section on the website which may have details of past purchases, sales, invoices, receipts and other relevant information. Thus, once the buyer 172 has logged in, they can perform administrative functions such as changing their password or updating their account, browse the median advertisement database 155 and/or purchase median advertising space by beginning a new search and/or purchase or resuming a saved search and/or purchase.

They can also use there log in to access their own members centre that will also be a place for storage of information related to them, such as marketing plans they have developed via the system.

A buyer 172 can search via the search engine for a particular media forum and certain target markets utilising various search criteria to find the appropriate advertising they require. By conducting a generalised search it is possible that the system may also introduce them to new media forums and/or target markets which they had not considered previously. If a buyer 172 has any queries relating to a given advertisement, they can contact the seller 173 directly via an online means to clarify the query or request further information by submitting a request/question online.

Once the buyer 172 is ready to purchase distressed advertising they can press a “buy” button which will cause a confirmation screen to appear confirming the advertising details and price to be paid. Once this information has been confirmed by the buyer, they will then be directed to a payment section having incorporated e-commerce facilities with a high security level so they can pay for the advertisement in a secure environment. Alternatively, they buyer 172 may apply for finance approval for the transaction, prior to purchase, whereby their details will be sent to the provider to approve their application for an account with the provider and/or third party finance company. Once payment has been received successfully, the buyer 172 will be shown a receipt showing the advertisement details, payment confirmation and deadline for the design/artwork to be submitted. The buyer 172 can then print this receipt, or return to a saved electronic version at a later date which will be stored in their member's section accessible when they log into the website. If a buyer 172 has not yet finalised the advertising content or design work for the advertising, they can arrange to use the services of a designer 176 who will complete the work prior to the publication or media deadline. Alternatively, they may request the seller organise and complete the creative work at the time of purchase if this is an option made available by the seller 173. A buyer 172 can also choose to be notified by email, sms, mail or any other suitable means if advertising is placed by a particular seller, for a particular media and/or target audience which they may be interested in.

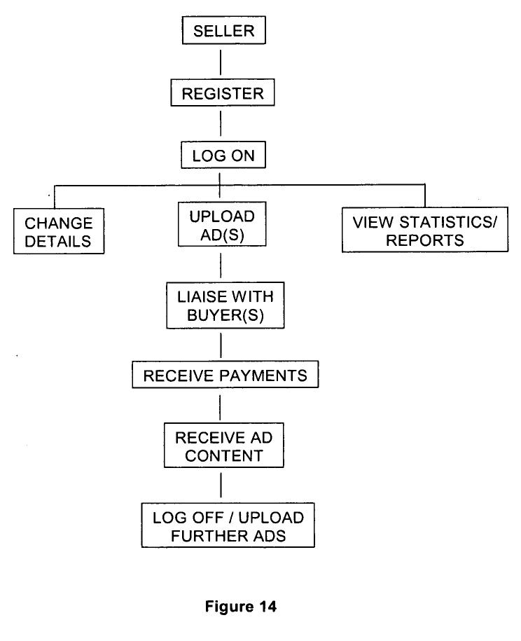

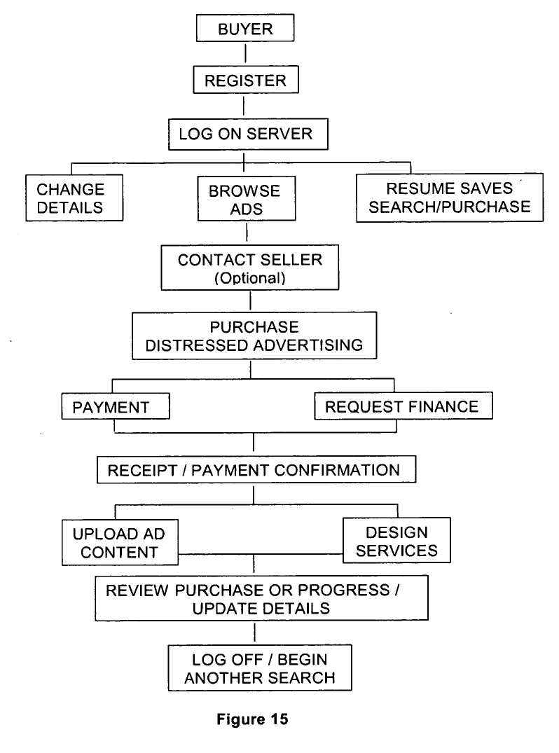

Referring to FIGS. 14 and 15 this method involves a seller 173 being able to sell last minute distressed advertising to potential marketers, advertising buyers and other professionals in a safe and secure manner. The seller 173 registers their details to become a member and gain full access to the online distressed advertising system and services provided. This can be done via the online portal/interface accessible through a seller's 173 computer via the internet. Once a seller 173 has provided their contact details and other necessary information, they are issued with a unique username and password which they can utilise to log onto the system or server 150 and have access to the services and facilities available. In this regard there may be a delay for approval by an account manager prior to utilising the system.

It will also provide them with access to their own personal member's section on the website which may have details of past purchases, sales, invoices, receipts and other relevant information. Thus, once the seller 173 has logged in, they can perform administrative functions such as changing their password or updating their account, search statistical information from associated databases as a resource tool and/or begin uploading and advertisement for distressed advertising.

The seller 173 is required to pay a prescribed fee which can be paid periodically or per advertisement. Once the payment has been received successfully the seller 173 can then upload one or more advertisements for distressed advertising onto the server 150. It is envisaged that once a seller 173 has uploaded an advertisement for the first time, they may have to await clearance for the advertisement to be approved. The seller 173 will also be able to liaise with a potential buyer 172 by receiving queries from potential buyers 172 and being able to respond to them via enquiry and feedback facilities provided by the invention. The seller 173 may also sign up to view statistical information collected by the system to monitor marketplace trends. Both the buyer 172 and seller 173 may also choose to purchase advertising on the website 17 of the system.

It is envisaged that the invention may also offer advertising to both buyers 2 and sellers 3 on the website 17 of the invention as a means for generating revenue for the provider 185. The provider may have provided account managers with restricted access such they are able to add/delete/modify accounts, assign contracts to sellers, manage banner advertising, control buyer and seller ratings and other specific duties as required.

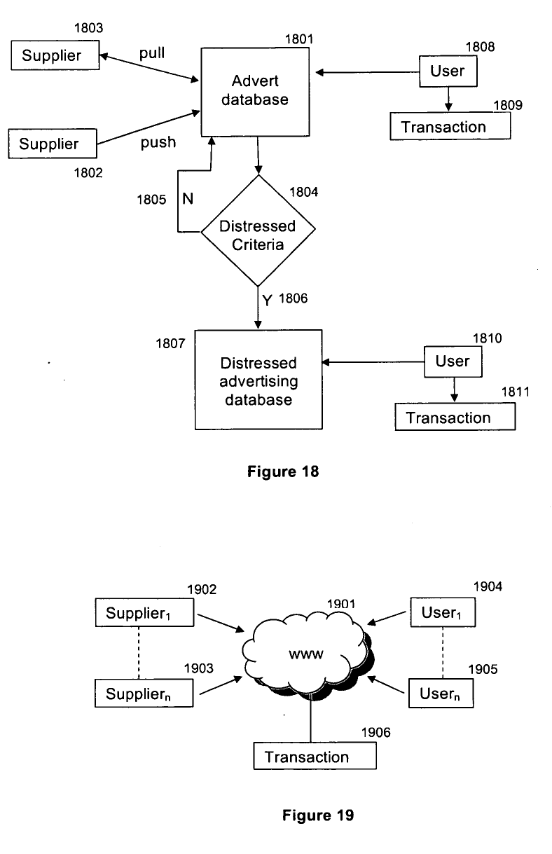

FIG. 18 illustrates a further embodiment of the present invention in which the system of the present invention may offer ‘normal’ (i.e. not distressed advertising), but after a certain criteria is met, that advertising is then offered as distressed advertising. For example, in accordance with this embodiment, a database 1801 is provided into which suppliers of advertising information or advertisements may push advertising 1802 or the present system may pull advertising from the supplier and/or supplier database 1803. In accordance with the present embodiment, criteria 1804 may be set. These criteria may include, without limitation:
Time since upload
Time since creation of advertising
Price
Time before media publication
User defined
Supplier defined
Any other criteria

If the criteria is not met 1805, the advertisement will remain designated as ‘normal’, not distressed. In this case, a user 1808, may wish to purchase advertising, and may do so via the database, offering normal advertising 1809.

If the criteria is met, 1806, the advertising is designation as distressed 1807. the distressed advertising may be passed into a separate database, but does not need to. A user 1810 how is looking for distressed advertising, may now have the opportunity to purchase 1811 advertising designated as ‘distressed’.

In FIG. 19, there is illustrated an embodiment of the present invention directed to providing advertising supply and purchase on an international basis. A database and/or system according to the present invention is provided at 1901. Preferably, the system is provided via a website and thus access via the Internet is convenient. Any number of suppliers (1 to n) and or providers 1902, 1903 of advertising information or advertising can subscribe or provide the advertising or advertising information to the database 1901. The suppliers may be based in any country, the same or different countries. Equally any number of users (1 to n) 1904, 1905 may subscribe to the present invention, and seek advertising in accordance with the various methods disclosed herein. When the user has located a suitable advertisement a transaction 1906 can occur.

The benefits this embodiment include, without limitation:
Global searching
Inter-country searching
Intra country searching
No real knowledge of media in other countries required by users to purchase media in other countries
Offers ability for users to learn about media available in other countries
Suppliers can market across boarders
Convenience

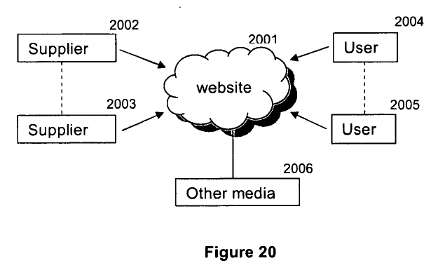

FIG. 20 illustrates yet another embodiment of the present invention, which seeks to address the need for SME's to access media advertising, although this aspect of the present invention may be used by anyone authorised to access the website. In this embodiment, media access, especially advertising media access is provided by way of a website 2001 into which advertising media can be uploaded by suppliers 1 to n (2002, 2003) and searched and viewed by users 1 to n (2004, 2005). Viewing of the media provides a form of advertising medium at relatively low cost and to a potentially large, even international audience.

A supplier 2002 may access the website 2001, create a profile which defines user details, then create and/or upload an advertisement in accordance with the disclosure herein. Once the advertisement is uploaded other users 2004 may access the website and search, for example for a company type, product type and/or business name or any other search criteria. A search of the contents of the website 2001 will return a number of ‘hits’ and provide a listing. The user may click on an individual entry in the listing and by clicking on the entry view the advertisement and/or view details associated with the entry. A form of print or other advertising 2006 may also be provided to the user as a consequence of viewing the advertisement listed.

It is to be appreciated that whilst the invention can also be applied to the offering and selling of regular advertising, for convenience sake it has be described herein in terms of a method and system for offering and selling distressed advertising.

It is to be appreciated that each of the methods are implemented in a computer system and thus may accordingly be termed computer system implemented methods. Furthermore, the present invention encompasses computer-readable medium bearing computer-executable instructions that, when executed, carry out at least one of the methods.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims.

Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. An advertising method comprising:
receiving advertisement information associated with advertising space; and
sending advertisement information having a relationship with the advertisement information received.

2. A method as claimed in claim 1, wherein the advertisement information relates to distressed advertising.

3. An advertising system comprising:
means for receiving advertisement information associated with advertising space; and
means for sending advertisement information having a relationship with the advertisement information received.

4. A method for coordinating information for use in advertising, the method comprising:
receiving sets of advertisement information associated with advertisements for distressed advertising space;
storing the sets of advertisement information; and
searching the stored sets of advertisement information to locate at least one set that meets with distressed advertising criteria.

5. A method as claimed in claim 4, wherein said receiving sets of advertisement information includes receiving sets of advertisement information each offering a distressed advertising space for sale.

6. A method as claimed in claim 5 including receiving sets of advertisement information each offering an advertisement for use in distressed advertising.

7. A method as claimed in claim 6, wherein the distressed advertising criteria is generated from a selected one of the sets of advertisement information each offering an advertisement for use in distressed advertising.

8. A method as claimed in claim 4, wherein said receiving sets of advertisement information includes receiving sets of advertisement information each offering an advertisement for use in distressed advertising.

9. A method as claimed in claim 8 including receiving sets of advertisement information each offering a distressed advertising space for sale.

10. A method as claimed in claim 9, wherein the distressed advertising criteria is generated from a selected one of the sets of advertisement information each offering a distressed advertising space for sale.

11. A method as claimed in any one of claims 4 to 10 including offering advertisements for distressed advertising space to a targeted group.

12. A method as claimed in claim 4 including offering distressed advertising space to a targeted group.

13. A method as claimed in claim 4, wherein the method is performed with the use of a computer network.

14. A method as claimed in claim 4, wherein the method includes providing a resource and a locator, the locator serving to identify graphical user interface for use in performing the method, the interface being connected to the resource.

15. A system for coordinating information for use in advertising, the system comprising:
receiving means for receiving sets of advertisement information associated with advertisements for distressed advertising space;
storing means for storing the sets of advertisement information; and
searching means for searching the stored sets of advertisement information to locate at least one set that meets with distressed advertising criteria.

16. A system as claimed in claim 15, wherein the receiving means for receiving the sets of advertisement information comprises means for receiving sets of advertisement information each offering a distressed advertisement space for sale.

17. A system as claimed in claim 15, wherein the receiving means for receiving the sets of advertisement information comprises means for receiving sets of advertisement information each offering an advertisement for use in distressed advertising.

18. A system as claimed in any one of claims 15, including means for providing an online graphical user interface via a world wide system

19. A system as claimed in claim 18, wherein the system operates using the World-Wide-Web.

20. A method for coordinating information for use in advertising, the method comprising:
receiving sets of advertisement information each offering an advertisement for use in distressed advertising;
storing the sets of advertisement information;
searching the stored sets of advertisement information each offering an advertisement to locate at least one set that meets with distressed advertising criteria.

21. A method as claimed in claim 20, including receiving a set of advertisement information associated with an offer of distressed advertising space for sale, the set of information containing the advertising criteria.

22. A method as claimed in claim 21, including controlling the set of advertisement information offering distressed advertising space for sale, such that an amount requested for the sale meets with a pricing schedule.

23. A method as claimed in claim 20, including prepopulating items for use in the set of advertisement information offering distressed advertising space for sale.

24. A method for coordinating information for use in advertising, the method comprising:
receiving sets of advertisement information each offering an advertising space for sale;
storing the sets of advertisement information;
searching the stored sets of advertisement information each offering an advertisement space for sale to locate at least one set that meets distressed advertising criteria.

25. A method as claimed in claim 24, including receiving a set of advertisement information associated with an advertisement for use in distressed advertising, the set of information containing the advertising criteria.

26. A method as claimed in claim 25, including controlling the set of advertisement information offering an advertisement for use in distressed advertising, such that an amount offered for the distressed advertising meets with a pricing schedule.

27. A method as claimed in 25, claim including prepopulating items for use in the set of advertisement information offering an advertisement for use in distressed advertising.

28. A method for coordinating information for use in advertising, the method comprising:
receiving a set of advertisement information associated with advertisements for advertising space, the set thereafter becoming a member of a number of received sets of advertisement information; and
providing an option of controlling the set of advertisement information to include a particular item and determining a sale amount according to the option.

29. A method as claimed in claim 28, wherein the set of advertisement information offers an advertising space for sale and the option comprises at least one of a desired colour, image, specialised display format, priority listing and target market listing.

30. A method comprising:
receiving a first set of advertisement information associated with a first publication media;
receiving a second set of advertisement information associated with a second publication media; and
forming a resultant set of advertisement information associated with a discounted package, said forming including combining the first set of advertisement information and the second set of advertisement information.

31. A method as claimed in claim 30, wherein said forming a resultant set of advertisement information is subject to the second publication media being different to the first publication media

32. A method as claimed in claim 31, including determining a sale amount that is discounted given that the first publication media is different to the second publication media.

33. A method as claimed in claim 30, including receiving three sets of advertisement information each associated with a respective publication media, the three sets including the first and second sets, and subject to the respective publication media being different, said forming including combining the respective sets of advertisement information.

34. A method of coordinating information for use in advertising, the method comprising:
receiving sets of advertisement information associated with advertisements for advertising space;
storing the sets of advertisement information; and
searching the stored sets of advertisement information to locate at least one set that meets with advertising criteria.

35. A method as claimed in claim 34, further comprising controlling the input of advertising criteria to specify a search selected from a group specifying at least a national or international based search.

36. A method as claimed in claim 34, wherein the advertising space is distressed advertising space.

37. A method for coordinating information for use in advertising, the method comprising:
receiving sets of advertisement information each offering an advertisement for use in distressed advertising; and
storing the sets of advertisement information;
wherein each of the sets of advertisement information, each offering an advertisement for use in distressed advertising, include an associated sale amount to enable searching according to distressed advertising criteria specifying a limitation on the associated sale amounts.

38. A method for coordinating information for use in advertising, the method comprising:
receiving sets of advertisement information each offering an advertisement for use in distressed advertising and including an associated sale amount;
storing the sets of advertisement information;
searching the stored sets of advertisement information each offering an advertisement to locate at least one set that meets with distressed advertising criteria specifying a limitation on the associated sale amounts.

39. A method for coordinating information for use in advertising, the method comprising:
initiating an auction;
receiving sets of advertisement information associated with advertisements for distressed advertising space and each including associated sale amounts; and
selecting, within the auction, one of the sets of advertisement information based on the associated sale amounts.

40. A method for coordinating information for use in advertising, the method comprising:
receiving sets of advertisement information associated with advertisements for advertising space; and
storing the sets of advertisement information; and
searching the stored sets of advertisement information to locate at least one set that meets with distressed advertising criteria;
wherein the sets of advertisement information relate to at least one media type selected from the group of print advertising, television advertising, radio advertising.

41. A method for coordinating information for use in advertising, the method comprising:
receiving a set of advertisement information associated with advertisements for banner advertising space; and
associating the set with a respective banner advertisement.

42. A method as claimed in claim 41, wherein associating the set with a respective banner advertisement includes building the banner advertisement.

43. A method for coordinating information for use in advertising, the method comprising:
receiving sets of advertisement information associated with advertisements for banner advertising space; and
connecting each of sets of advertisement information such that each set is associated with a respective banner advertising space and a respective banner advertisement.

44. A method as claimed in claim 43, wherein the set of advertisement information comprises an offer of banner advertising space and/or an offer of a banner advertisement.

45. A method as claimed in claim 43, including storing the sets of advertisement information; and searching the stored sets of advertisement information to locate at least one set that meets with banner advertising criteria.

46. A method for coordinating information for use in advertising, the method comprising:
receiving a set of advertisement information associated with advertisements for advertising space, the set thereafter becoming a one of a number of received sets of advertisement information; and
providing an option of including a particular item associated with a donation to community conscious party.

47. A method as claimed in claim 46, wherein each of the sets of advertisement information each offer a advertisement space for sale and the option comprises letting the community conscious party use the advertisement space if the advertisement space is not sold within a predetermined time period.

48. A method for coordinating information for use in sponsorship, the method comprising:
receiving a set of sponsorship information associated with a sponsorship; and
offering a sponsorship based on the set of sponsorship information received.

49. A method for coordinating information for use in sponsorship, the method comprising:
receiving sets of sponsorship information associated with a potential sponsorship; and
connecting each of sets of sponsorship information such that and each set is associated with a respective sponsorship.

50. A method for coordinating information for use in advertising, the method comprising:
allowing the selection of an offer of advertisement space; and
offering a build service to build an advertisement in order that the advertisement will be prepared with a predetermined time frame.

51. A method for coordinating information for use in advertising, the method comprising:
receiving a set of advertisement information associated with advertisements for distressed advertising space
offering a build service to build an advertisement in order that the advertisement will be prepared with a predetermined distressed time frame.

52. A method as claimed in claim 51, wherein offering the design service to build an advertisement using an online environment is provided so that the design is built within 30 minutes.

53. A method as claimed in claim 51, wherein offering the design service to build an advertisement using an online environment is provided so that the design is built within 1 hour.

54. A method as claimed in claim 51, wherein offering the design service to build an advertisement using an online environment is provided so that the design is built within a few hours.

55. A method as claimed in claim 51, wherein offering the design service to build an advertisement using an online environment is provided so that the design is built within 12 hours.

56. A method as claimed in claim 51, wherein offering the design service to build an advertisement using an online environment is provided so that the design is built within 48 hours.

57. A method as claimed in claim 51, wherein offering the design service to build an advertisement using an online environment is provided so that the design is built within 3 days.

58. An advertising method comprising creating a session and, within the session, arranging for the purchase of advertising space, the design of an advertisement and the supply of the designed advertisement within a predetermined time frame.

59. A method for coordinating information for use in advertising, the method comprising:
receiving sets of advertisement information associated with advertisements for distressed advertising space;
storing the sets of advertisement information;
searching the stored sets of advertisement information to locate at least one set that meets with distressed advertising criteria; and
sending an alert to a party associated with the at least one set that meets with the distressed advertising criteria.

60. A method for coordinating information for use in advertising, the method comprising:
receiving sets of advertisement information each offering an advertisement for use in distressed advertising
storing the sets of advertisement information;
searching the stored sets of advertisement information each offering an advertisement to locate at least one set that meets with distressed advertising criteria; and
sending an alert to a party when a set is located that meets with the distressed advertising criteria.

61. A method as claimed in claim 60, wherein the alert comprises:
the manner in which the alert is to be provided to the user, such as SMS or email, or other medium,
frequency, which defines how often the search is to be repeated in order to once again check to see if there is available an advertisement that matches the user's criteria, sponsorship,
keyword when used or input into the database, and/or
other predetermined criteria, for example as defined by the user.

62. A method as claimed in claim 3 wherein the search comprises any one or any combination of:
publication type,
price range,
campaign date,
media type,
territory,
postcode,
deadline or end date,
words and/or indicia,
other criteria as defined by a user.

63. A method as claimed in claim 60, wherein sending the alert comprises sending the alert to a party offering an advertisement for use in distressed advertising.

64. A method as claimed in 60, wherein sending the alert comprises sending an urgent alert requiring the party to reply within a distressed time period to purchase distressed advertising space.

65. A method as claimed in claim 60, wherein the method requires that the party has an advertisement completed and ready to make a deadline.

66. A method as clamed in claim 65, wherein distressed time period less than 2 days and the deadline is less than 3 days.

67. A method as clamed in claim 65, wherein distressed time period less than about 12 hours and the deadline less than about 2 days.

68. A method as clamed in claim 65, wherein distressed time period about 30 minutes and the deadline about a couple of hours.

69. A method for coordinating information for use in advertising, the method comprising:
receiving sets of advertisement information each offering an advertising space for sale;
storing the sets of advertisement information;
searching the stored sets of advertisement information each offering an advertisement space for sale to locate at least one set that meets with distressed advertising criteria; and
sending an alert to a party when a set is located that meets with the distressed advertising criteria.

70. A method for coordinating information for use in advertising, the method comprising:
a buyer uploading advertising criteria to a database,
notifying at least one supplier of the advertising criteria
notifying the buyer of an acceptance or rejection of the advertising criteria.

71. A method as claimed in claim 70, wherein the notification is via an alert.

72. A method as claimed in claim 70, wherein the criteria comprises any one or any combination of:
media type,
price,
campaign date,
territory,
postcode,
deadline or end date,
other criteria as defined by the buyer.

73. A method as claimed in claim 69, comprising the further step of removing the advertising criteria from the database if there are no acceptances by suppliers.

74. A method as claimed in claim 70, wherein the advertising criteria comprises an advertisement.

75. A method as claimed in claim 70, wherein at least one criteria of the advertising criteria comprises distress.

76. A method for coordinating information for use in advertising, the method comprising:
receiving sets of advertisement information associated with advertisements for distressed advertising space;
storing the sets of advertisement information;
searching the stored sets of advertisement information to locate at least one set that meets with distressed advertising criteria; and
highlighting particular sets of advertisement information when said particular sets of advertisement information repetitively do not meet distressed advertising criteria.

77. A method as claimed in claim 76, wherein highlighting the sets of advertisement information comprises providing an online publication directing readers to said particular sets.

78. A method for coordinating information for use in advertising, the method comprising:
receiving sets of advertisement information associated with advertisements for distressed advertising space; and
maintaining statistics on the sets of advertisement information.

79. A method for coordinating information for use in advertising, the method comprising:
receiving sets of advertisement information associated with advertisements for distressed advertising space;
searching the stored sets of advertisement information to locate at least one set that meets with distressed advertising criteria; and
maintaining statistics of the sets of advertisement information.

80. A method as claimed in claim 79, wherein maintaining statistics includes maintaining statistics of which of the stored sets of advertisement information are being repetitively searched.

81. A method for determining information for use in advertising, the method comprising:
receiving a set of advertisement information associated with advertisements for distressed advertising space;
facilitating the calculation of an indication of a required return on investment associated with the set of advertisement information using an online system.

82. A method as claimed in claim 81 including suggesting at least one advertisement or at least one distressed advertising space based on the calculation.

83. A method as claimed in claim 81, including suggesting a marketing strategy.

84. A system for buying and/or selling distressed advertising wherein the system includes:
a server having at least one database accessible by at least one subscribing buyer and/or at least one subscribing seller in order to buy and/or sell distressed advertising;
an online interface in the form of a website which provides means for said buyer(s) and/or seller(s) to interact with the server;
a means for enabling said seller(s) to directly upload at least one advertisement for available distressed advertising detailing all relevant information pertinent to said distressed advertising including a fixed price for at least one advertisement;
a search means for enabling said buyer(s) to search and select available distressed advertising; and
a payment means for enabling said buyer(s) to directly purchase distressed advertising.

85. A system as claimed in claim 84, further comprising a means for enabling said buyer(s) to directly upload advertising content.

86. A system for buying and/or selling distressed advertising as claimed in claim 84.

87. A system as claimed in claim 84, wherein said distressed advertising is offered and/or bought at a discounted rate.

88. A method for buying and/or selling distressed advertising wherein the method includes the following steps of:
providing a server over a distributed communication network, said server having at least one database accessible by at least one subscribing buyer and/or at least one subscribing seller in order to buy and/or sell distressed advertising;
said seller(s) directly uploading at least one advertisement for use in distressed advertising;
said buyer(s) searching for available distressed advertising by entering at least one search criteria to receive search results detailing available distressed advertising meeting said search criteria via a search means;
said buyer(s) selecting at least one distressed advertisement and directly purchasing selected distressed advertising.

89. A method as claimed in claim 88, further comprising the step of:
said buyer(s) directly uploading advertising content.

90. A method as claimed in claim 88.

91. A method as claimed in claim 88, wherein said distressed advertising is offered and/or bought at a discounted rate.

92. A method and system of buying and/or selling distressed advertising as claimed in claim 88, further comprising a design service wherein following purchase of distressed advertising, said buyer(s) can select to have design or creative work completed and uploaded by said design service prior to a specified publication deadline.

93. A method of designating advertising as distressed advertising, the method comprising the steps of:
providing advertising information in a database
providing predetermined criteria adapted to designate whether the advertising is normal or distressed advertising
applying the predetermined criteria to the advertising.

94. A method as claimed in claim 93, wherein the advertising information includes advertisements.

95. A method as claimed in claim 93, wherein the criteria comprises:
a. Time since upload
b. Time since creation of advertising
c. Price
d. Time before media publication
e. User defined
f. Supplier defined

96. A method as claimed in claim 93, wherein the criteria is applied periodically and/or continuously to advertising information in the database.

97. A method as claimed in claim 93, further comprising the step of forwarding an alert following designation of the advertising as distressed.

98. A method as claimed in claim 1, wherein the advertising relates to or is associated with any or any combination of retail advertising, discount advertising, block advertising, or distressed advertising.

99. A system as claimed in claim 3, wherein the advertising relates to or is associated with any or any combination of retail advertising, discount advertising, block advertising, or distressed advertising.

100. A system as claimed in claim 15, wherein the advertising relates to or is associated with any or any combination of retail advertising, discount advertising, block advertising, or distressed advertising.

101. A system as claimed in claim 84, wherein the advertising relates to or is associated with any or any combination of retail advertising, discount advertising, block advertising, or distressed advertising.

102. A method as claimed in claim 4, wherein the searching is conducted on an international basis.

103. An online system adapted to provide an advertising medium, the system comprising:
providing a database into which a first user can upload a advertisement content
providing online access to a second user to enable the second user to view the content.

104. A system as claimed in claim 103, further comprising providing a search adapted to locate content in accordance with search criteria.

105. A system as claimed in claim 103, wherein multimedia content is also uploaded in association with the advertising content.

106. An apparatus including:
processor means adapted to operate in accordance with a predetermined instruction set,
said apparatus, in conjunction with said instruction set, being adapted to perform the method as claimed in any one of the preceding claims.

107. A computer program product including:
a computer usable medium having computer readable program code and computer readable system code embodied on said medium for use in providing or coordinating distressed advertising as disclosed herein within a data processing system, said computer program product including: computer readable code within said computer usable medium.

108. A method as substantially described herein with reference to the accompanying drawings.

109. A system as substantially described herein with reference to the accompanying drawings.

110. A method of providing advertising, the method comprising the steps of:
selecting a medium in which to place the advertising, and
providing the advertising content, at least partially in accordance with the method as claimed in claim 1.
